(19) United States
(12) Patent Application Publication
(10) Pub. No.: US 2025/0261789 A1
(43) Pub. Date: Aug. 21, 2025

(54) Automatic Cooking Machine

(71) Applicant: Willem Nicolaas van Rensburg, Jinan (CN)

(72) Inventor: Willem Nicolaas van Rensburg, Jinan (CN)

(21) Appl. No.: 18/552,163

(22) PCT Filed: Sep. 26, 2022
(86) PCT No.: PCT/CN2022/121363

§ 371 Date: May 9, 2025

(30) Foreign Application Priority Data
Jul. 2, 2021 (CN) 202121501902

(51) Int. Cl. A47J 36/32; A47J 36/16; A47J 43/044; A47J 44/00; B25J 11/00

(52) U.S. Cl. CPC A47J 36/32; A47J 36/165; A47J 43/044; A47J 44/00; B25J 11/0045

(57) ABSTRACT

The present invention relates to an automatic cooking machine comprising a frame with a plurality of subsystems, wherein the frame is closed by a cover and comprises the following subsystems: a user interface device, an ingredient storage system, a robotic arm, a water supply system, an additive dispenser arm, a cooking system, a set of tools for food preparation and cooking, a waste disposal system, and a sensor. The machine is managed by a computerized controller that serves as its control system. The user interface device is mounted on the front of the machine. The controller stores a program that sends signals to the various mechanical subsystems within the machine. Guided by this program, the controller skillfully directs the appropriate components to perform the required operations. The present invention is meticulously designed, compact, and user-friendly.

### FIELD OF INVENTION

The present invention relates to an automatic cooking machine.

### BACKGROUND OF THE INVENTION

Preparing and cooking a meal is a process that takes time. Most working people need to rest after coming home from work, but cooking is an additional activity that takes up their rest time.

Most people don't have extensive knowledge or skill in cooking. Therefore, they cook only simple meals, or they cook a limited number of meals that they know how to cook. Most people would like to have the opportunity to enjoy a variety of meals at home but they are usually not given this opportunity because of their lack of cooking knowledge and skills.

There are several electric cooking appliances that can perform food preparation or cooking processes. However, these appliances can only perform one or two processes (chopping, cooking rice, etc.) and they are not versatile enough to cook a complete meal.

Therefore, there is a need for an all-in-one machine that can cook a variety of dishes and perform all the steps for preparing and cooking a complete meal, without any human involvement.

The prior art shows several attempts to provide such a solution. Patent no. CA 2933095 describes a robotic arm that mimics the actions of a human chef during the food preparation and cooking process. A robotic hand, similar to a human hand, is attached to the end of the robotic arm. The robotic hand then can hold conventional kitchen tools to perform various cooking operations. However, this adds unnecessary complexity. A human hand can do much more than hold and manipulate a kitchen tool, e.g., push, carry things, punch, etc. The ultimate goal of a robotic cooking arm is to perform certain end-of-tool actions, such as moving the tool up and down (slicing) or moving the tool in continuous short arcs (stirring). This can be achieved in a system with much less complexity and cost. There is also a risk that the robotic hand may not hold the tool properly as it depends on a complex mechanical system (5 fingers grabbing the tools with different handle thicknesses and profiles), and that the tool may fall out of the hand.

U.S. patent number 2015/0114236 describes a robotic arm with a mixing tool permanently attached to it. This system is simpler and more reliable than a robotic hand system, but it has limited application because the tool can only perform one function.

Many of the existing patents describe a machine for use in a home, consisting of a robotic arm, a food storage area, and a cooking area. However, these designs fail to address the need for the machine to be compact, in order to fit into a home kitchen. U.S. Pat. No. 10,154,756 T describes a system with a footprint of between 16 and 32 square feet and consisting of a set of robotic arms and cabinets, not mounted on a common frame. Apart from its bulkiness, the system is impractical in the sense that it cannot be delivered to the home as a complete machine. Instead, the kitchen would essentially have to be remodeled to accommodate it.

In general, the prior art does not provide a compact, versatile, and cost-effective solution for a machine that can perform a full range of food preparation and cooking operations. In addition, none of them address the problem that all equipment and working table need to be cleaned after use, and that waste (fish bones, vegetable peels, etc.) needs to be disposed of after cooking. These systems are therefore not fully automatic.

In conclusion, the present invention provides a solution that can address the shortcomings of the prior art, as outlined above.

### SUMMARY OF THE INVENTION

The technical problem to be solved by the present invention generally provides an automatic cooking machine. The present invention is reasonable in design, low in cost, strong and durable, safe and reliable, simple in operation, saves time and effort, saves money, has a compact structure, and is easy to use.

The present invention relates to an automatic cooking machine comprising a frame with a plurality of subsystems, wherein the frame is closed by a cover and comprises the following subsystems: a user interface device, an ingredient storage system, a robotic arm, a water supply system, an additive dispenser arm, a cooking system, a set of tools for food preparation and cooking, a waste disposal system, and a sensor. The machine is managed by a computerized controller that serves as its control system. The user interface device is mounted on the front of the machine. The controller stores a program that sends signals to the various mechanical subsystems within the machine. Guided by this program, the controller skillfully directs the appropriate components to perform the required operations. The present invention is meticulously designed, compact, and user-friendly.

### BRIEF DESCRIPTION OF THE DRAWINGS

FIG. 1 shows a perspective view of the machine.

FIG. 2 shows a perspective view of the machine with the covers and user interface hidden to display the subsystems of the machine.

FIGS. 3, 4, and 5 show perspective views of the ingredient storage system and frame from three different angles (partial cross section).

FIG. 6 shows a perspective view of the ingredient storage system with one of the trays pulled out in the Y direction.

FIG. 7 shows a perspective view of the ingredient storage system with one of the trays pulled out in the X direction.

FIG. 8 shows a perspective view from the rear of the first lifting system of the ingredient storage system.

FIG. 9 shows a perspective view of the compartment locking system in the unlocked position.

FIG. 10 shows a perspective view of the compartment locking system in the locked position.

FIG. 11 shows a perspective view of the counterweight bar and a partial view of the lifting cable.

FIG. 12 shows a side view of the counterweight bar and a partial view of the lifting cable.

FIG. 13 shows a rear and side views of the machine with the cover removed and with the ingredient storage system in the rest position.

FIG. 14 shows a perspective view from the rear of the machine with the cover removed and with the ingredient storage system raised to align the middle of the compartment and the table.

FIG. 15 shows a perspective view of the machine with one of the front covers in the raised position.

FIG. 16 shows a perspective view of the machine with a tray popping out from a position below the raised cover.

FIG. 17 shows a perspective view from the left of the machine with a part of the cover removed to show the compartments aligned with the front covers.

FIG. 18 shows a perspective view of the robotic arms in different positions and the frame (partial cross section).

FIG. 19 shows a perspective view of the robot end.

FIG. 20 shows a perspective view of the motor coupling.

FIG. 21 shows a perspective view of the frame (partial cross section) as well as the four cooking pots and with two of the pots in partial cross section to display the cooking plates below them.

FIG. 22 shows a perspective view of the frame (partial cross section) as well as the set of cooking pots with one of the pots hidden from view to display the pot rotator.

FIG. 23 shows a perspective view of the pot rotator to display the features the pot rotator on the pot for positioning.

FIG. 24 shows a perspective view of the frame (partial cross section) and the tools in the stored position on their holding bays.

FIG. 25 shows a perspective view of a tool on the specific position above the holding bay system (partial cross section).

FIG. 26 shows a perspective view of a tool on the specific position in the holding bay system (partial cross section).

FIG. 27 shows a perspective view of a set of pot handling tools.

FIG. 28 shows a perspective view of the rotating brush tool.

FIG. 29 shows a perspective view of the gripper tool.

FIG. 30 shows a front perspective view of the robot end and the motor coupling.

FIG. 31 shows a perspective view of the water supply system and frame (partial cross section).

FIG. 32 shows a perspective view of the liquid soap bottle, its mounting bracket, the flow control valve, pipe, and tank fitting on top of the water tank.

FIG. 33 shows a bottom perspective view of the neck of the liquid soap bottle, positioned above the open end of its mounting bracket.

FIG. 34 shows a top perspective view of the neck of the liquid soap bottle, positioned above the open end of its mounting bracket.

FIG. 35 shows a front perspective view of the water supply system and the frame (partial cross section) to display the valve subsystem and pipes connected to the water tank.

FIG. 36 shows a front perspective view of the valve subsystem of the water supply and the frame (partial cross section).

FIG. 37 shows a rear perspective view of the water supply system and the frame (partial cross section) to display the valve subsystem from a different position.

FIG. 38 shows a rear view of the valve subsystem of the water supply system and the frame (partial cross section).

FIG. 39 shows a perspective view of the additive dispenser arm in a spare position.

FIG. 40 shows a rear perspective view of the valve end of the dispenser arm.

FIG. 41 shows a front perspective view of the valve end of the dispenser arm.

FIG. 42 shows a perspective view of an internal tray with additive bottles stored in it.

FIG. 43 shows a bottom perspective view of a bottle for storing cooking additives.

FIG. 44 shows a bottom perspective view of the bottle for storing cooking additives (partial cross section), and its valve mechanism in an uncompressed state.

FIG. 45 shows a bottom perspective view of the bottle for storing cooking additives (partial cross section), and its valve mechanism in a compressed state.

FIG. 46 shows a perspective view in the area of the waste disposal system is located.

FIG. 47 shows a perspective view of the components of the waste disposal system.

FIG. 48 shows a side view of the components of the waste disposal system.

FIG. 49 shows a perspective view of the remaining area of the machine with the waste bin removed.

FIG. 50 shows a perspective view of the serving bowls in the spare position.

FIG. 51 shows a rear perspective view of the washing station.

FIGS. 52-54 show perspective views of the 3 steps of engaging the motor coupling with a tool and removing it from the holding bay.

FIG. 55 shows a front view of the machine with the covers and screen removed and the middle compartment in place of the internal compartment, where the robotic arm can pull out the internal tray.

FIG. 56 shows a front view of the ingredient storage system, with the top compartment in a position lifted a part from the middle compartment.

FIG. 57 shows a perspective view of the robot end with its motor coupling aligned with the keyhole slot in the interior tray.

FIG. 58 shows a perspective view of the robot end with its motor coupling engaged in the keyhole slot in the interior tray.

FIG. 59 shows a perspective view of the machine with its covers removed to display a carrot being lifted by an interior tray.

FIG. 60 shows a perspective view of the machine with its covers removed to display the first step of the process of peeling a carrot.

FIG. 61 shows a perspective view of the machine with its covers removed to display the second step of the process of peeling a carrot.

FIGS. 62-65 show perspective views of the machine with its covers removed to display four different food preparation and cooking operations.

FIG. 66 shows a perspective view of the machine with its covers removed to display the dispenser arm being moved into position with its dispensing end above the pot.

FIG. 67 shows a perspective view of the additive bottle being positioned above the cup in the dispenser arm.

FIG. 68 shows a perspective view of the dispenser arm in the position above the pot.

FIG. 69 shows a perspective view of the machine with its covers removed to display the soap bottle being removed from the mounting bracket.

FIG. 70 shows a perspective view of the machine with its covers removed to display the kitchen waste being chopped up.

FIGS. 71-74 show perspective views of the machine with its covers removed to display the different steps of removing a pot from its position in the cooking station, tilting the pot, and discharging the liquid contents into the waste disposal slot.

FIG. 75 shows a front perspective view of the machine with its covers removed to display the serving bowl being removed from its tray.

FIG. 76 shows a perspective view of the machine with its covers removed to display the tool being washed.

FIGS. 77-78 show perspective views of the machine with its covers and frame removed to display an onion being peeled.

FIG. 79 shows a perspective view of a rotatable spike tool.

FIG. 80 shows a perspective view of a carrot being held between a rotating tool mounted on the robotic arm and the rotatable spike tool.

FIG. 81 shows a perspective view of a spring tool for holding an item to press down in place while it is being cut.

### DETAILED DESCRIPTION OF THE PREFERRED EMBODIMENTS

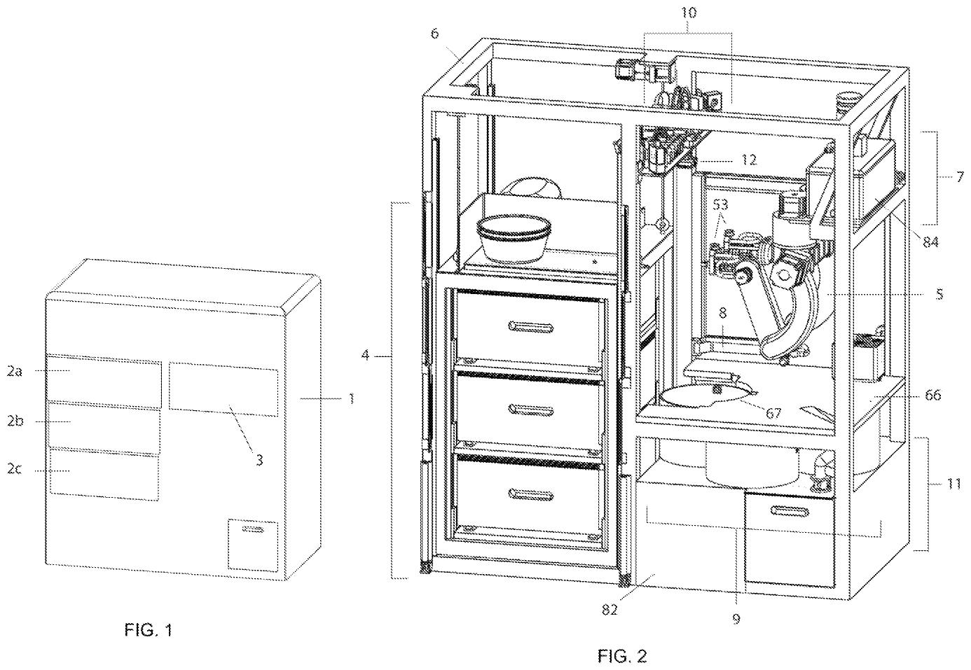

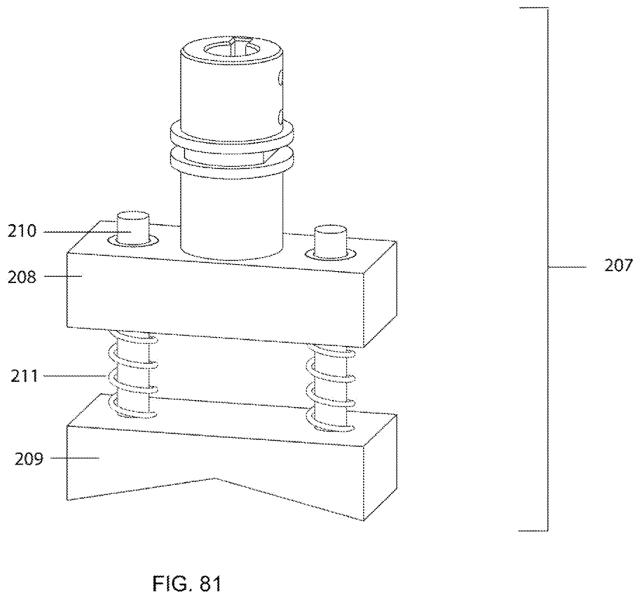

As shown in FIGS. 1-81, the machine described in the present invention, specifically the automatic cooking machine, can complete all steps of food preparation and cooking (including automatic cleaning and waste disposal) without any manual intervention. In this document, the drawings explain the present invention. In diagrams, some components are sometimes invisible in order to clearly show the components behind them. When a component is shown in one diagram but not in another, it should be understood that the component is present but may be hidden in some diagrams. This is illustrated below:

Refer to FIGS. 1 and 2. The machine consists of a frame 6 on which several subsystems are mounted. The frame 6 consists of a frame closed by a cover 1. The subsystems comprising: a user interface device 3, an ingredient storage system 4, a set of robotic arms 5, a water supply system 7, a dispenser arm 8 for dispensing additives, a cooking system 9, a set of tools 10 for food preparation and cooking, a waste disposal system 11, and a sensor 12.

The machine is controlled through a computerized controller (not shown). The user interface device is installed on the front of the machine. A program is stored in the controller. The program sends signals to various mechanical subsystems in the machine, then the controller controls the appropriate components to complete appropriate steps in accordance with the program.

The present invention includes a description of the operation of the machine. Unless otherwise indicated, all such operational steps are achieved through control signals from the controller.

A set of food preparation and cooking recipes are stored in the controller. Each of them details the various steps for preparing a particular meal. Each step is detailed in a machine code, for communicating with the various subsystems that will participate in that step.

A sensor 12 is connected to the controller and is mounted on the frame. The sensor is preferably a camera sensor that can record visual information and send it as data to the controller.

The data from the sensors is also used to monitor the different stages of the cooking process (e.g., checking the color of the meat to determine if it has been cooked completely). The data is fed back to the controller and compared to a visual reference image stored in a database. In the example of cooking meat, if the program does not match the visual reference image, the program is set to continue cooking, and then another image is taken (e.g., after one minute) to compare against the reference image. If the image matches the image within the tolerance set by the program, the controller sends a signal to the cooking system, the heating system shuts down, and cooking is complete.

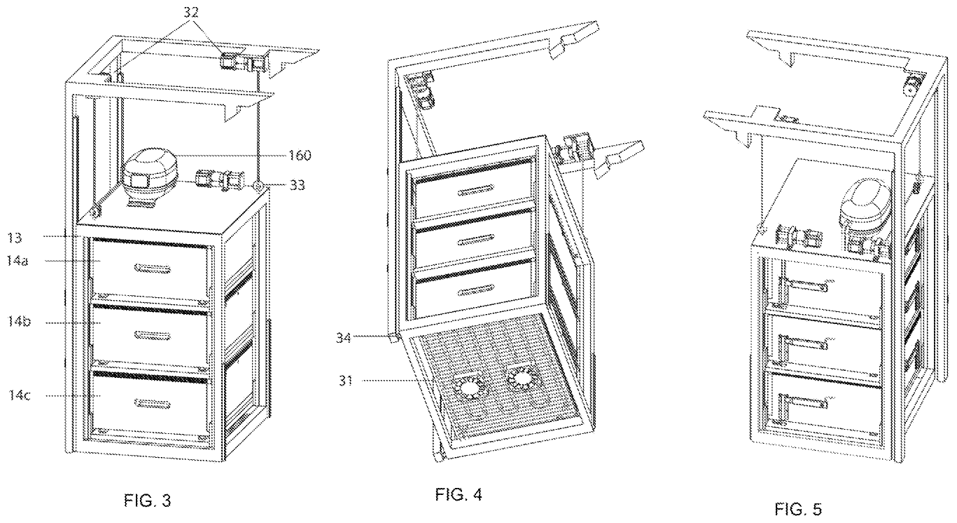

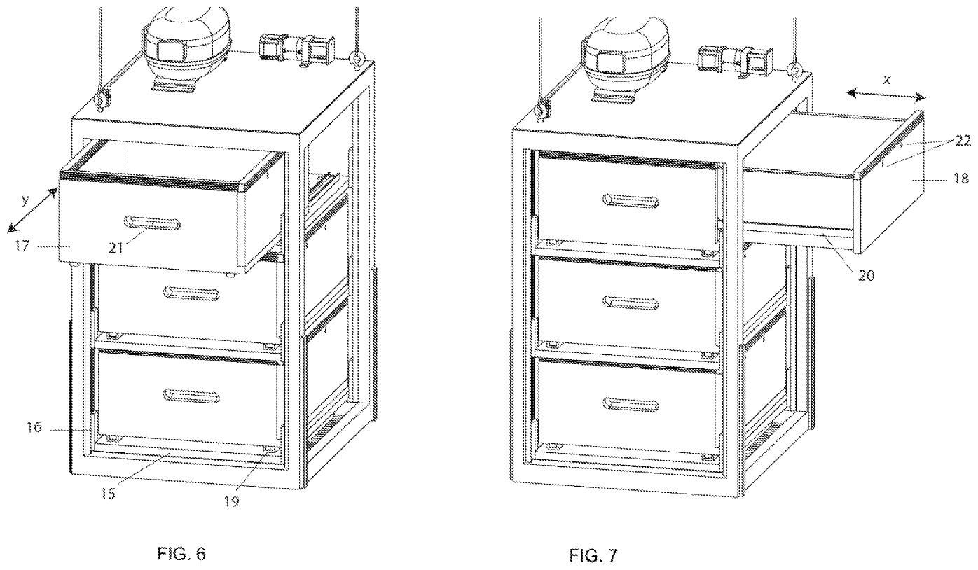

Refer to FIGS. 3-5. The ingredient storage system consists of a compartment box 13 and three storage compartments 14a-14c. Refer to FIGS. 6 and 7. Each storage compartment consists of a base 15 and a tray set. The base is attached to the inside of the compartment box through a vertical slider arrangement 16. A tray set consists of an exterior tray 17 and an interior tray 18. The exterior tray is attached to the base through a slider arrangement 19 which allows it to slide in the Y direction from a retracted position to an extended position and return. The interior tray is attached to the inside of the exterior tray through a slider arrangement 20 which allows it to slide in the X direction from a retracted position to an extended position and return. A recess 21 is located at the front of the exterior tray. The recess allows the user to grip the tray and to pull out. A set of recesses 22 is located on the front of the interior tray, each of which is in the shape of a keyhole corresponding to the shape of the motor coupling (described later).

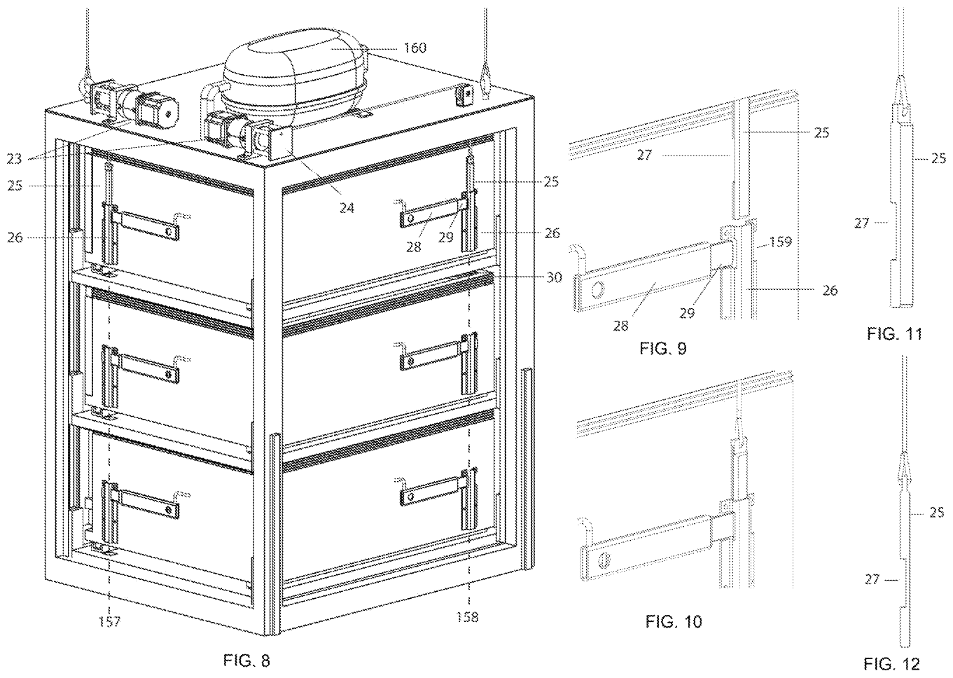

Refer to FIGS. 8-10. The compartment box has a first lifting system for moving the compartments up or down inside the compartment box. The lifting system consists of the following components:

A set of motors 23, which may be stepper motors or servo motors. the stepper motor is a brushless DC electric motor that divides a full rotation into an equal number of steps. A servo motor is a closed loop servo mechanism that uses positioning to control shaft rotation. Both types of motors have the same advantages that the speed and rotation of their shafts can be accurately controlled. Servo motors and stepper motors are therefore suitable for producing mechanical motion in a machine that requires high positioning accuracy. The shafts of the motors are each attached to a cable winch 24.
A counterweight bar 25 with a horizontal slot 27 is attached to the end of each cable. Each of the compartments have a set of vertical guide tracks 26 for guiding the counterweight bar in a vertical direction. When the counterweight bar is lifted downward, it slides over the guide track. When all the external trays in three compartments are in a retracted position, the guide tracks will be vertically aligned, with alignment indicated by dotted lines 157 and 158. Once the guide tracks are aligned, the counterweight bar drops and passes through all guide tracks.
A linear actuator 28 is mounted next to each guide track in the compartments. The linear actuator may be an electric or pneumatic type. The linear actuator is positioned so that a slider 29 will slide forward and backward horizontally, and pass through the counterweight bar in a vertical direction through a recess 159 on the guide track. Refer to FIG. 9. If the counterweight bar is lifted downward and stopped correctly in position in the guide track, it will create a path for the slider to move forward through the recess 159 into the horizontal slot in the counterweight bar. This operation locks the two components together, as shown in FIG. 10. When the components are locked together, the entire compartment box will be lifted or lowered if the counterweight bar is lifted or lowered by a cable winch.

The counterweight bar is normally locked onto the lowest compartment. This allows the cable winch to pull the lowest compartment to the overhead position. By continuing to pull upward, all compartments are pulled together and the top edge of the top compartment 14a is pulled up to the ceiling of the compartment box. A rubber strip 30 is fitted along the top edge of each of the compartments, which prevents outside air from flowing into the compartment when pulling the compartments and the compartment box together.

Refer to FIGS. 3 and 4. A refrigeration system consisting of a heat exchanger system 31 and a compressor 160 is fitted into the compartment box. Cool air from the refrigeration system flows into the compartment closest to it. Each compartment has an air flow passage (not shown) which aligns with an air flow passage (not shown) in the next compartment when the compartments are in the spare position. This allows cold air to flow from one compartment to the next, so that the cold air can be shared by all the compartments.

When the compartments are pulled together, the trays cannot slide forward or backward in the X or Y direction. If the trays from a particular compartment need to slide in either direction, a gap needs to be created between the top, and the above surface of that compartment. This is achieved by lifting the above compartments upward, by using a lifting and locking system.

A second lifting system allows the entire storage system to move vertically up and down inside the frame. This is achieved via two stepper motors 32 with the cable lugs 33 fixed to the compartment box. The compartment box is fitted to the frame via a slide mechanism 34, this allows the compartment box to slide up and down when it is lifted.

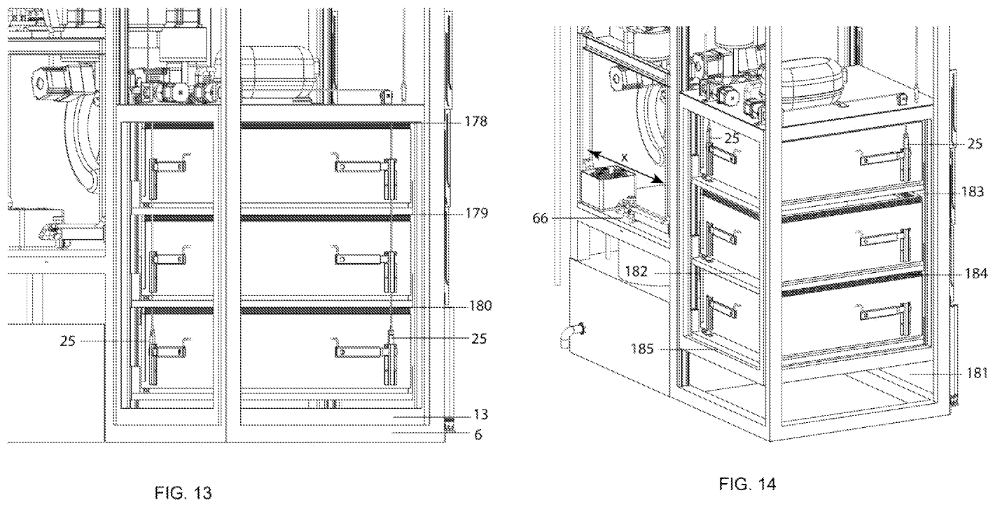

Refer to FIG. 13, showing the ingredient storage system in the rest position when the machine is not in use. The compartment box 13 is lowered by the second lifting system and places on the frame 6. The counterweight bar 25 is aligned with the actuators on the bottom compartment 14c and locked onto the slider. The counterweight bars are lifted up so that the bottom compartment is against the middle compartment as shown by line 180. The middle compartment is against the top compartment as shown by line 179. The top compartment is against the compartment box, as shown by line 178.

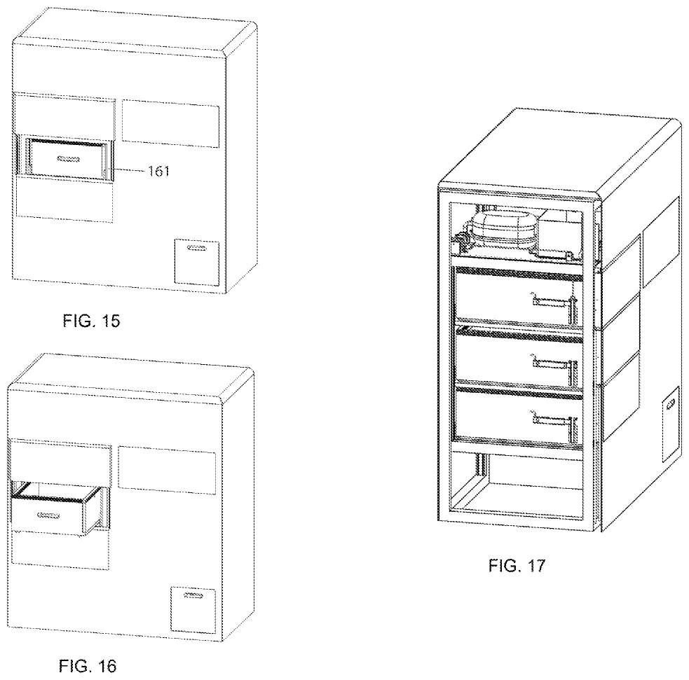

Refer to FIG. 14. The middle compartment 14b where the ingredient storage system is located can be pulled out in the X direction. The compartment box is lifted up by the second lifting system, which creates a gap 181 between the bottom of the compartment box and the frame 6. The bottom edge 182 of the middle compartment is slightly above the table 66. The counterweight bars 25 are locked onto the top compartment. The top compartment is lifted up by the first lifting system, which creates a gap 183 between the middle compartment and the top compartment. It also makes the middle compartment to place on the bottom compartment as shown by line 184 and makes the bottom compartment to place on the compartment box as shown by line 185. In this arrangement, the interior tray of the middle compartment (not shown) has some sliding freedom in the X direction.

Refer to FIG. 1. A set of covers 2a-c are mounted on the front of the machine. Each cover has a sliding mechanism (not shown) which allows it to slide up and down. Refer to FIG. 15. When a cover is in the raised position, there is a gap 161 appeared underneath the cover, allowing access to the rest of the machine from the outside. As shown in FIG. 6, the compartment box can be lifted to align with this gap so that a user can pull the external tray out of one of the compartments to place ingredients into the tray. When the user closes the tray, the path of the lid is no longer obstructed and it can be slid down again.

The second lifting system allows the compartment box to be lifted or lowered to different positions as may be required. For example, it can be lowered so that the compartments are aligned with the front covers, as shown in FIG. 17.

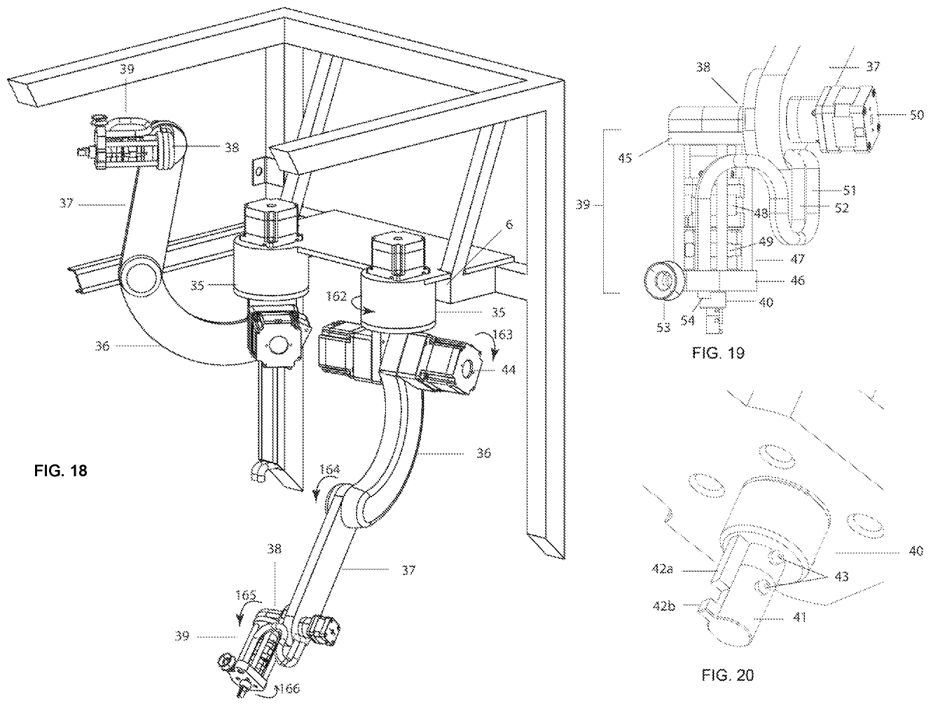

Refer to FIG. 18, Showing the robotic arms with their components are in different positions. Each robotic arm consists of a shoulder 35 and a number of arm sections. The shoulder is mounted on the frame 6 and can rotate on either side in direction 162. A first arm member 36 is mounted on the shoulder and can rotate on either side in direction 163. A second arm member 37 is mounted on the first arm member and can rotate on either side in direction 164. A joint 38 is mounted on the second arm member and can rotate on either side in direction 165. An arm end 39 is mounted on the joint 38 and can rotate on either side in direction 166. The rotation of the shoulder, the arm, and the end sections is achieved through the electric motors. The motors can be the servo motors or the stepper motors. The rotation of the shoulder 35, first arm member 36, and the joint 38 is achieved through a motor shaft being concentrically aligned with the axis of rotation. The rotation of second arm member 37 is achieved through a motor 44 mounted away from it and is connected to it through a belt and pulley system (not shown) mounted inside the first arm member 36.

Refer to FIG. 19. A motor 50 is mounted on the second arm member 37 and its shaft is connected to the joint 38. The rotation of the shaft actuates the joint 38 to rotate in direction 165 (as shown in FIG. 18). An arm end 39 consists of a top plate 45, a base plate 46, and four shafts 47 which are fixed onto plates 45 and 46 to hold them apart from each other. A motor 48 is mounted onto the top plate 45 and its shaft is connected to the joint 38. The rotation of the shaft actuates the arm end 39 to rotate on the joint 38 in direction 166 (as shown in FIG. 18). A motor 49 is mounted on the base plate 46. A motor coupling 40 is mounted on the shaft of the motor 49. The rotation of the motor shaft actuates the motor coupling to rotate. A water pipe 51 extends from the second arm member 37 to the arm end 39 with a water nozzle 54 protruding through the bottom of base plate 46. The water pipe extends along the length of the robotic arm, and its opposite end is connected to a water supply system 7 (not shown). A vacuum passage (not shown) inside the base plate 46 connects an open end of vacuum pipe 52 to a vacuum suction cup 53 which is mounted in the base plate 46.

Refer to FIG. 20. The motor coupling 40 has a round shaft 41 which is mounted with flat key bars 42a and 42b. It also has a set of pins 43, each pin has a rounded tip to insert to a hole on the shaft. The hole is slightly bigger than the pin so that the pin can slide in and out. A small compression spring (not shown) is mounted behind each pin inside the shaft and pushes it outwardly. When pressure is applied to the pin, the pin can slide inward towards the center of the shaft and compress the springs. When the pressure is released, it will be pushed outward by the springs.

Refer to FIG. 18, showing the two robotic arms in different orientations. By changing the angles between the shoulder and the first arm member, and between the arm members and the arm ends relative to each other, the robot ends can move to various positions. The robot arms can move from a retracted position to an extended position, allowing the robot ends to reach any position in the food preparation area.

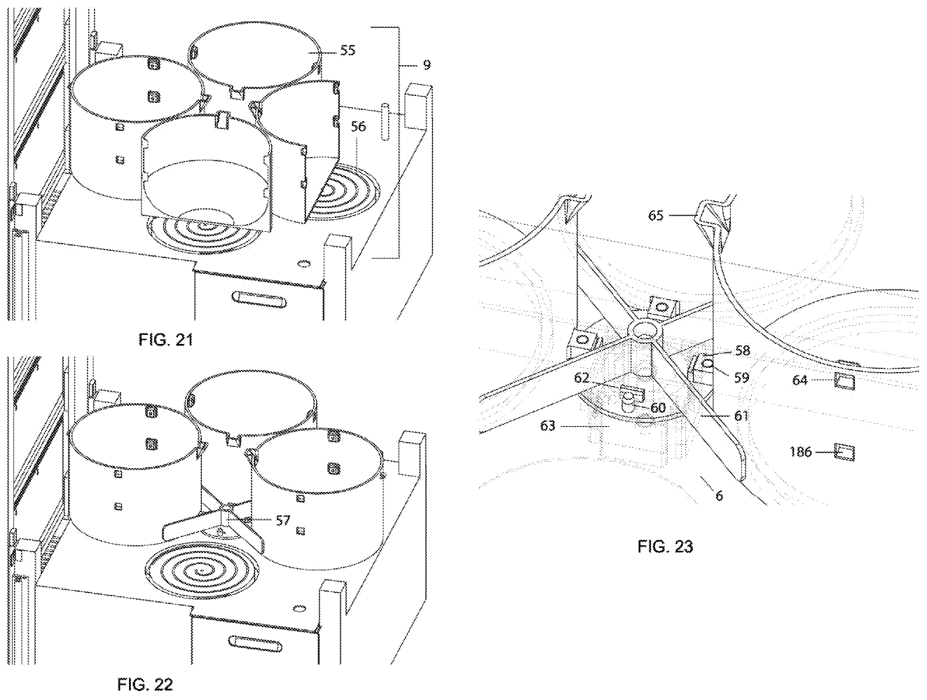

Refer to FIG. 21. The machine also comprises a set of cooking pots 55 in the cooking system 9. A cooking plate 56 is mounted on the frame and located under each cooking pot. Refer to FIG. 22. The cooking pot is detachably mounted on a pot rotator 57. Refer to FIG. 23. Each cooking pot has a block protrusion 58 with a hole 59. The hole corresponds with a pin 60 on the pot rotator. The hole is slightly bigger than the pin so that the pot can be lifted vertically and thus be temporarily separated from the pot rotator. Through a set of arms 61 and a block protrusion 62 on the pot rotator that can keep the pots stable on the pot rotator and prevents them from pivoting around the pins when the pot rotator is in motion. The rotation of the pot rotator is created by a stepper motor 63 mounted on the frame 6 underneath the pot rotator and fixed to the pot rotator with its shaft. There are 4 pot positions in the cooking system, the position of the cooking plates determines the position of the pots. The pots can be moved to different positions in the cooking system by rotating the pot rotator.

Each pot has a spout 65 to facilitate pouring the liquid. Each pot has a set of square recesses 64 on its top outer surface, to allow the robotic arms to lift the pot off the pot rotator. Each pot has a set of square recesses 186 on its middle outer surface, to allow the robotic arms and the pot handling tools to tilt the pot in order to discharge its contents. The lifting and tilting processes will be described in the section of ‘Operation of the Invention’.

Refer to FIG. 2. The machine has a table 66 on which food preparation takes place, for example chopping vegetables or rolling dough. The table is located directly above the pots. The table has a semi-circular recess 67. When all the pots are in position on the plates, wherein three of the pots are covered by the table and one of the pots is located below the semi-circular recess. The closed area of the table serves as a lid for the pots. The semi-circular recess is the point where ingredients can be added to the pot or food can be removed from it. It is also the point where a pot can be lifted off the pot rotator and moved to the work table. In accordance with the machine program, any pot can be moved to the open or closed area by rotating the pot rotator.

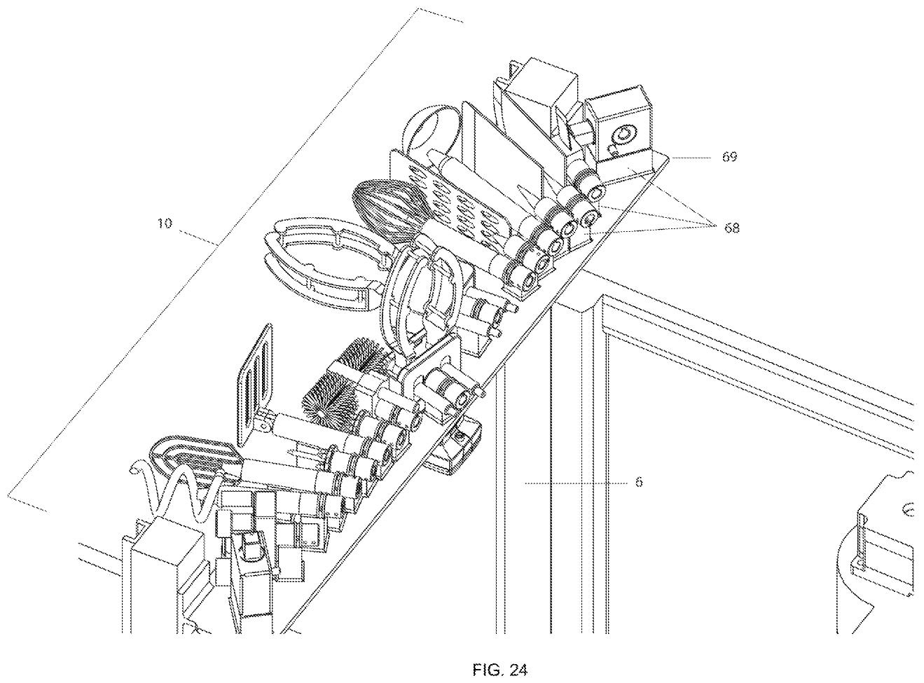

Refer to FIG. 24. A set of tools 10 are located on the top section of the machine. These lay-flat can be secured to the front of the robot end and can be moved from one area of the machine to another. Each tool is stored in its own holding bay 68, which is located on the mounting plate 69 of the frame 6.

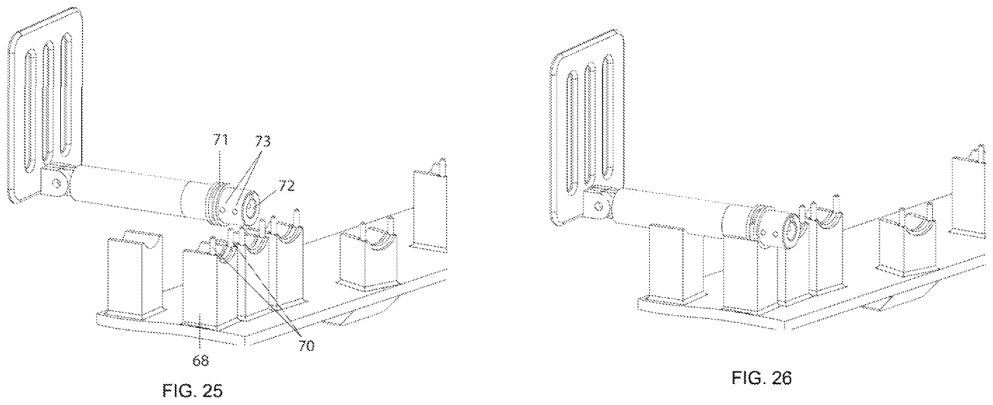

Refer to FIGS. 25 and 26. When not in use, the tools are stored and secured in a holding bay. FIG. 25 shows the tool placing on the holding bay, and FIG. 26 shows the tool in the spare position. The shape of the holding bay 68 corresponds to the shape of the tool so that the tool can be held in the corresponding position. The holding bay has a set of vertical pins 70 and the tool has a recess groove 71 that corresponds to a gap between the vertical pins. This allows a sliding fit between the pins and the grooves so that the tool is held in place by the pins and prevents the tool from moving back and forth horizontally.

The machine connects the tools to the robotic arms. Each tool has an orifice 72 with a shape which corresponds to the shape of the motor coupling. The tool has a set of holes 73 on top that correspond to the spring pins on the motor coupling. The process of mounting the motor coupling on the tool will be described in detail in the section of ‘Operation of the Invention’.

The machine contains a variety of tools that can be used to perform different food preparation operations. These include (but are not limited to) the tools for: chopping, slicing, grating, stirring, mixing, rolling, crushing, and dishing up.

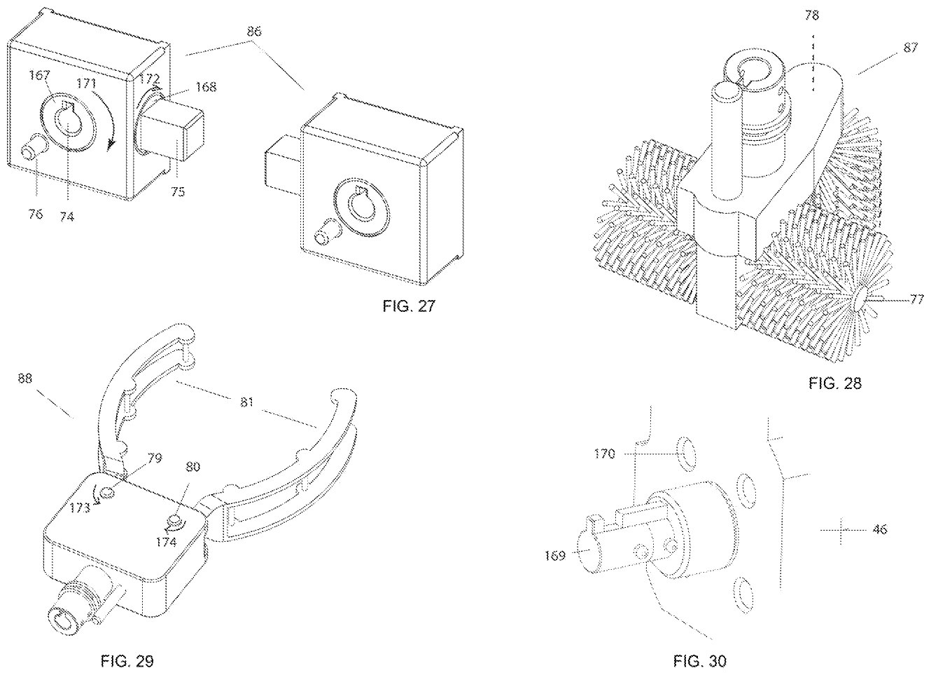

Refer to FIGS. 27 and 28. The tool set includes a set of pot handling tools 86 for lifting and tilting the cooking pots. Each pot handling tool consists of a right-angle gearbox mechanism (not shown). An orifice 74 is formed in the center of a rotatable first shaft 167. The profile of the orifice corresponds to the profile 169 of the motor coupling (as shown in FIG. 30). The tool has a rotatable second shaft 168 with a square end 75. The first shaft is connected to the second shaft through an internal gearset (not shown). The tool set has an anti-rotation pin 76 next to the rotatable first shaft, the position of the pin corresponds to the position of a hole 170 on the front face of the base plate 46 on the robotic arm, and the pin is slightly smaller than the hole so that it can slide into the hole. When mounting the tool to the robotic arm, the pin prevents the body of the tool from rotating with the motor shaft rotation. The rotation of the motor shaft shown by direction arrow 171 is transmitted through the gearset to the square shaft, causing it to rotate in direction shown by arrow 172.

Refer to FIG. 28. The tool set includes a rotating brush tool 87. The design of the brush tool is the same as the pot handling tools, but instead of one square protruding shaft. The tool set has a first shaft 77 and a second shaft, both of them are not visible and their axis is indicated by line 78. A round brush is mounted on each shaft. When the motor shaft rotates, the brush rotates. The brush tool is used for cleaning the interior of the pots and other work surfaces after the pots have been used.

Refer to FIG. 29. The tool set includes at least one gripper tool 88. The design of the gripper tool is the same as the pot handling tools, but the first rotatable shaft is connected to a rotatable second shaft 79 and a rotatable third shaft 80 through an internal gearset (not shown). The gear arrangement causes the second shaft to rotate in direction 173 and the third shaft to rotate in direction 174, both in opposite direction. A set of gripper jaws 81 are attached to the second and third shafts. The rotation of the motor shaft causes the gripper jaw to open and close. The gripper jaws are used for picking up ingredients from the ingredient storage area and for changing ingredients. With the gripper jaw, it is also possible for one robotic arm to hold certain ingredients while the other robotic arm performs an operation on them (e.g., holding and peeling potatoes).

Refer to FIG. 2. The machine has a motor compartment 82, located below the cooking area. The motor compartment contains the equipment such as a compressor and vacuum generators (not shown). The equipment make noise when they are in use. The motor compartment is lined with a soundproofing material (not shown) for dampening the sound.

The vacuum suction cups 53 are connected through a hose to the vacuum generator located in the motor compartment. The suction cups are used for lifting or holding certain ingredients (e.g., picking up an egg and opening it so that it fits snugly against the edge of another tool on another robot arm).

The machine has a system for supplying water to various points on the machine. A water tank 84 is located at the top of the machine. The water tank is connected to a tap through a hose that supplies water to the building.

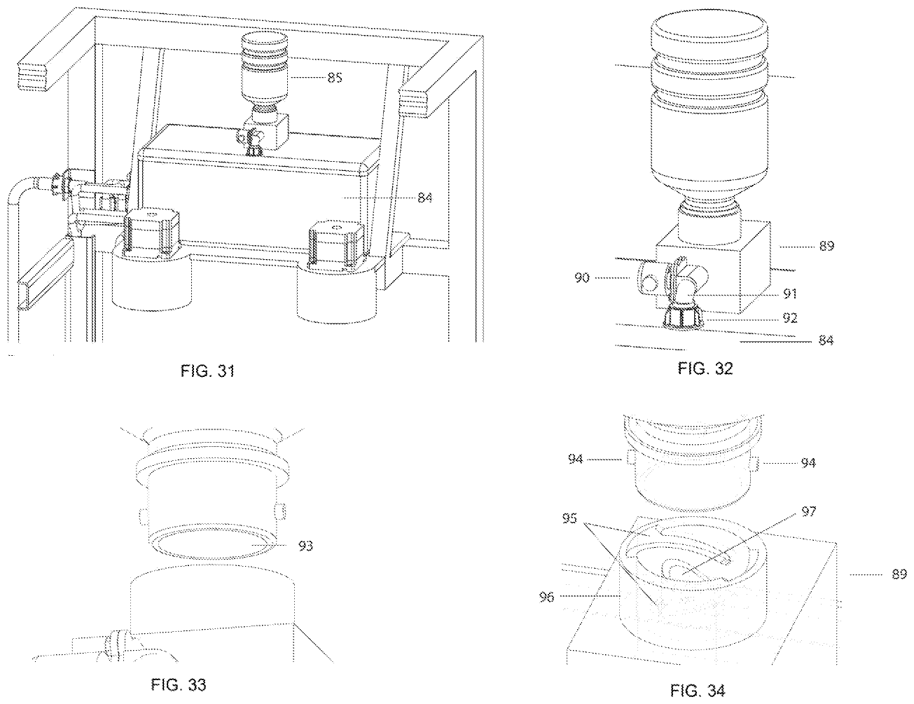

Refer to FIG. 31. The machine has a system for producing liquid soap. A bottle 85 containing the liquid soap is mounted on top of the water tank and release the liquid soap. The bottle is mounted with the mouth facing downward. Refer to FIG. 32. A bottle mounting bracket 89 is connected to a flow control valve 90, which is connected via a pipe 91 and a tank fitting 92 to the water tank 84. Refer to FIG. 33. Prior to use, a cover 93 made of aluminum foil is sealed on the opening of the bottle. Refer to FIG. 34. A set of protrusions 94 are provided on the neck of the bottle. The upper member of the mounting bracket 89 consists of a ring neck 96. A set of spiral grooves 95 correspond to the size and location of the protrusions 94, allowing the bottle to be lowered into the mounting bracket and then locked into place. A rigid tube protrusion 97 with a sharp end face is located inside of the ring neck 96. The rigid tube 97 is connected to a cover 93 through a flow passage (not shown) inside of the mounting bracket 89. When the bottle is mounted to the bracket 89, the seal 90 is punctured by the sharp end face of rigid tube protrusion 97 and the liquid soap flows from the bottle to the flow control valve. The flow control valve is connected to the controller to receive a signal for opening or closing, to release liquid soap from the bottle into the water tank as required.

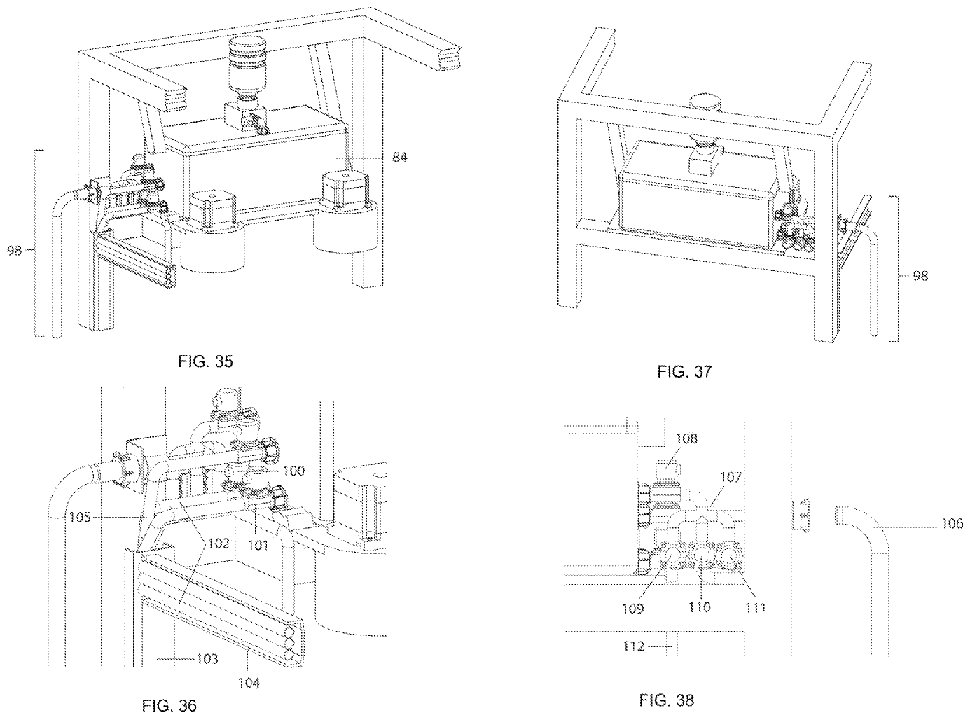

Refer to FIGS. 35 and 37. A set of pipes and flow control valves 98 are mounted on the water tank 84. Refer to FIG. 38. Water is supplied to the machine from the building's water supply system through a pipe 106. Through a manifold 107, the water supply also can branch off to various flow control valves. A valve 108 supplies water to the water tank. A valve 109 supplies water to one of the robotic arms through a pipe 112. A valve 110 supplies fresh water for rinsing to the dispenser arm (described later). A valve 111 supplies fresh water for rinsing to the washing station (described later). Each flow control valve is connected to various points on the machine through a hose and supplies water to those points. Refer to FIG. 36. Through two flow control valves 100 and 101, the soap liquid from the water tank is dispensed into place for washing. Through the hose, each flow control valve is connected to and supply water to various points on the machine. The water flows to two points on the machine through the pipes. The pipes are housed inside of a wire box. The Pipe 102 enters a vertical w ire trough 103, then bends 90 degrees and extends continuously along a horizontal wire trough 104 towards the dispenser arm (described later). The Pipe 105 extends down the vertical wire trough 103 to the washing station (described later).

The controller sends signals to the flow control valves to dispense water in accordance with the machine program.

A heater element (not shown) is mounted inside the water tank to heat up the water in accordance with the program.

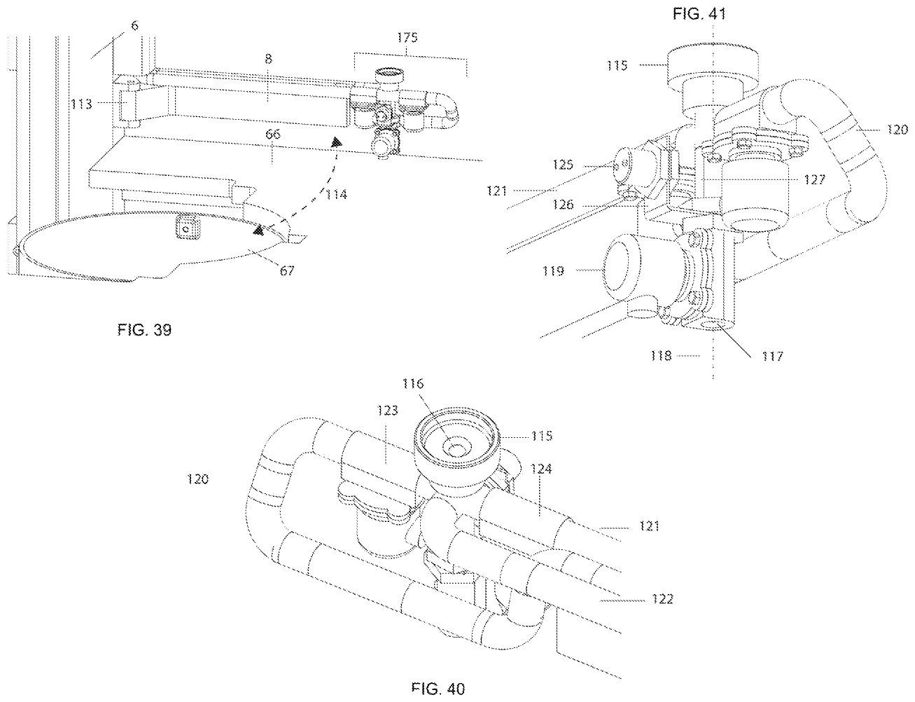

The machine has a system for dispensing cooking additives, for example, liquid additives (such as oil and vinegar) or dry additives (such as sugar, salt, and spices). Refer to FIG. 2. The additive dispenser arm 8 is mounted on the frame. Refer to FIG. 39. The additive dispenser arm 8 is mounted on the frame 6 by means of a hinge 113. As shown, the additive dispenser arm is located at the rear of the machine when not in operation. The swinging path of the additive dispenser arm is an arc 114, thereby positioning its dispensing end 175 above a point on the table 66. The additive dispenser arm can also swing further along the arc to position the dispensing end above the semi-circular recess 67 in the table.

Refer to FIGS. 40 and 41. A cup 115 is located at the top of the additive dispenser arm having a vertical channel which is indicated by line 118. The top of the channel 118 is a hole 116 and the bottom is another hole 117. A flow control valve 119 is mounted in a straight line along the channel 118. A pipeline 120 for transporting soap liquid is connected to the channel 118. A pipeline 121 for transporting fresh water is connected to the channel 118. A pipe 122 for transporting compressed air is connected to the channel 118. A flow control valve 123 controls the flow of soap liquid to the channel 118. A flow control valve 124 controls the flow of clear water to the channel 118. A valve (not shown) in the motor compartment controls the flow of compressed air to the channel 118. A flow sensor 125 is mounted on a right-angle bracket 126 opposite to a transparent window 127 in the channel 118. The flow sensor is used for measuring the amount of additives flowing through the channel 118.

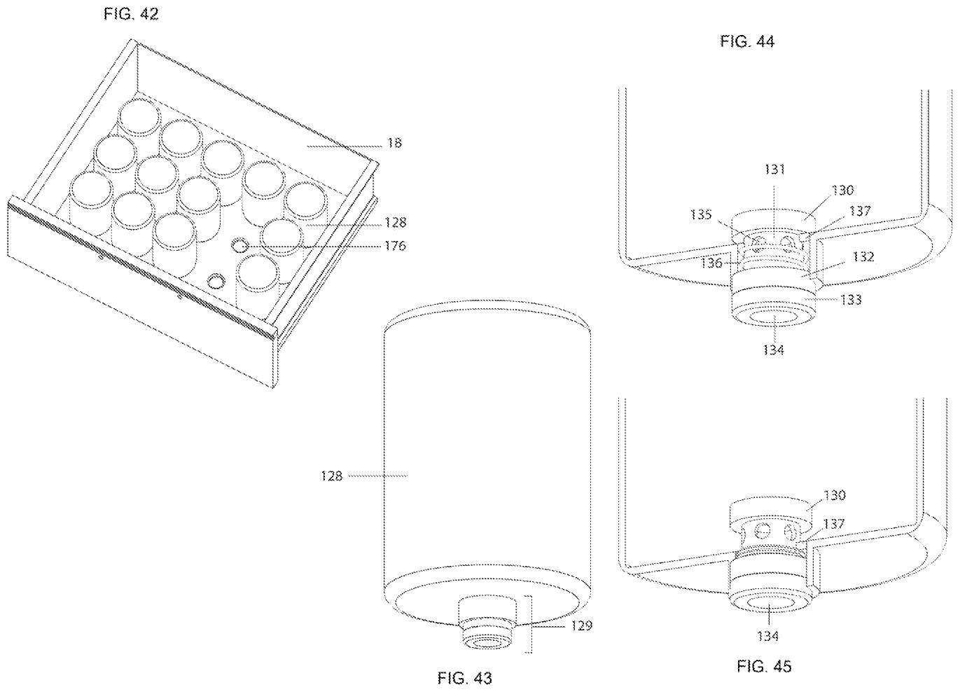

The cooking additives are stored in bottles. Each bottle has a spring valve mechanism mounted in the bottle neck. Refer to FIG. 42. The Bottles are stored in the ingredient storage system with the valve mechanism facing down. A Recess 176 is located in the bottom of the interior tray 18 to be inserted into the neck of the bottle.

Refer to FIG. 43. A condiment bottle 128 has a flow control device 129 equipped with a compression spring located inside its neck. Refer to FIG. 44. The valve mechanism comprises a plug head 130, a round tube 131, and a ring 133. The round tube 131 has a series of holes 135 around the circumference of the tube, which creates a flow passage: pass through the holes 135, down through the round tube 131, and out through a hole 134. The outer diameter of ring 133 is slightly smaller than the inner diameter of the bottle neck, thus allowing the condiment bottle to slide in and out of the ring 133. A sealing ring 132 is mounted on a pipe section above the ring 133 with the same outer diameter as the round tube. A compression spring 136 is mounted between an annular confinement zone 137 in the bottle neck and the sealing ring. Pressing down on the compression causes the bottom surface of plug head 130 to press against the top surface of the annular confinement zone 137, Blocking the passage from the inside of the bottle to the round tube.

Refer to FIG. 45. When pressure is applied to the valve mechanism from below, the plug head 130 is pushed to open at the annular confinement zone 137, the hole in the round tube is exposed to the interior of the bottle so that the contents in the bottle can flow out of the mechanism through hole 134.

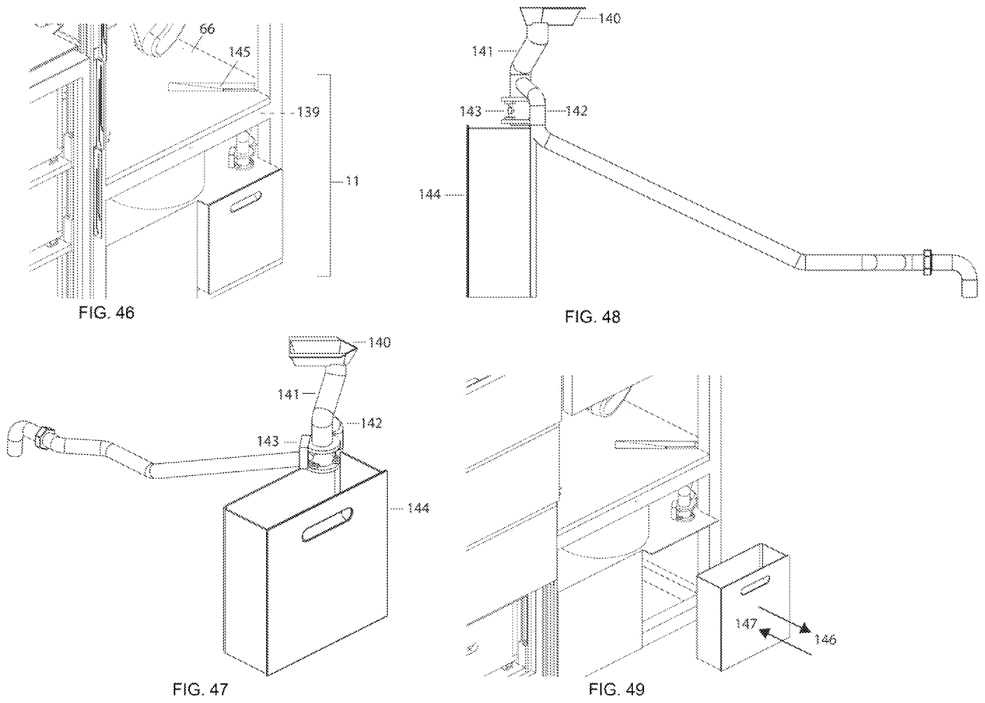

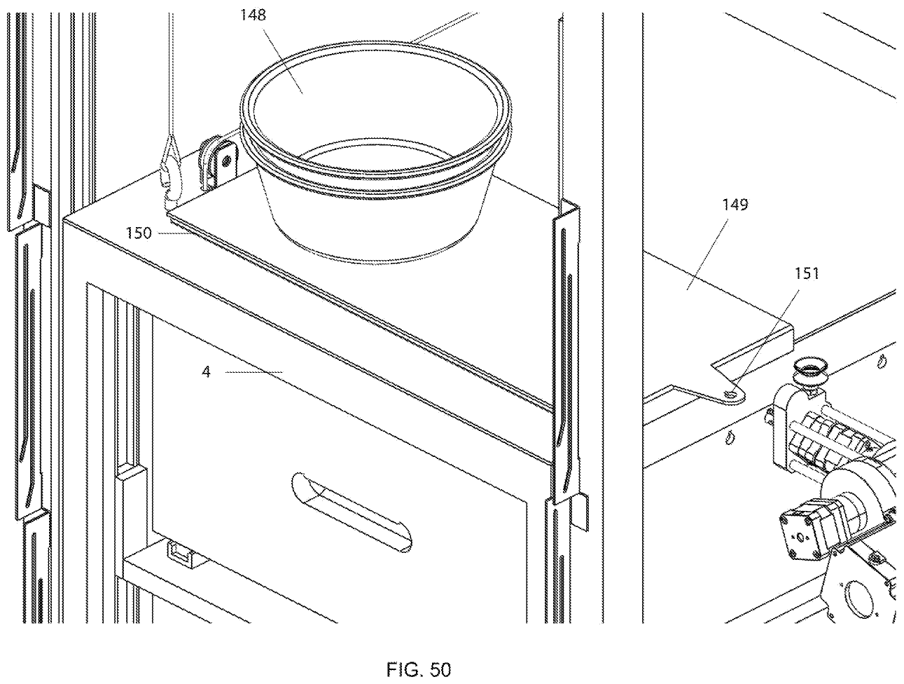

Refer to FIG. 46, showing the waste disposal system. The table 66 is equipped with a waste disposal opening 145. A funnel (not shown) is located below the opening. The position of the funnel is indicated by line 139. Refer to FIGS. 47 and 48. The waste disposal system consists of the funnel 140, a solid waste line 141, a liquid waste line 142, a flow control valve 143. and a waste bin 144. A flow control valve 143 is positioned above the opening of the waste bin. The waste bin is detachably mounted in a recess of the machine cover. The valve is normally open so that solid waste can fall through the funnel into the waste bin. When the valve is closed, the flow is transferred to the liquid waste line 142, which slopes downward and extends along the side of the machine towards the rear side, where it extends outside the machine. The opening end of the liquid waste line 142 is connected to the drain system of the building. The position of the valve is controlled by the program, the solid waste is deposited into the waste bin and the liquid waste is discharged from the rear of the machine. Refer to FIG. 49. The waste bin can be manually removed from the recess by pulling in direction 146. The waste bin can be manually replaced by pushing in direction 147.

Refer to FIG. 50. The machine has a set of serving bowls 148 in which the cooked meals are placed. Serving bowls are normally stored in a stacked arrangement on a flat tray 149, which is located on the top of the ingredient storage system. Through a slide mechanism 150, the tray is connected to the top of the compartment. The tray has an opening 151 at one edge of a side, which corresponds to the profile of the motor coupling on the front of the robotic arm.

Refer to FIG. 51. The machine has a washing station 152 for washing the tools after use. The station consists of a basin vessel 153, which contains brushes 154. A pipe 105 is connected to a flow control valve 100 (not shown) of the water supply system to dispense soap liquid into the basin vessel and a pipe 155 is connected to a valve 110 (not shown) of the water supply system to dispense clear water into the basin vessel. The basin vessel has an outlet valve (not shown) at its bottom for releasing the used water from the rear of the machine through a pipe 156.

### Operation of the Invention

This section describes the main operations of the machine.

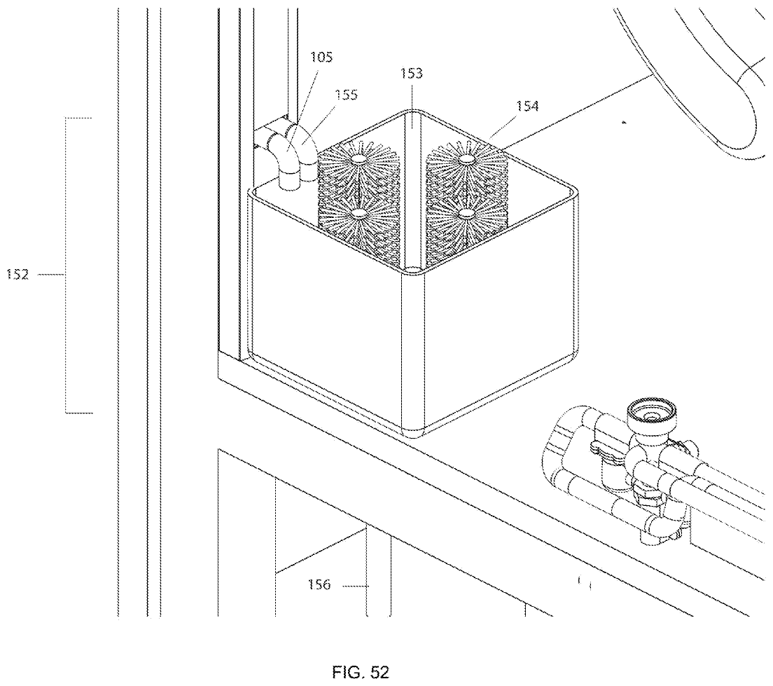

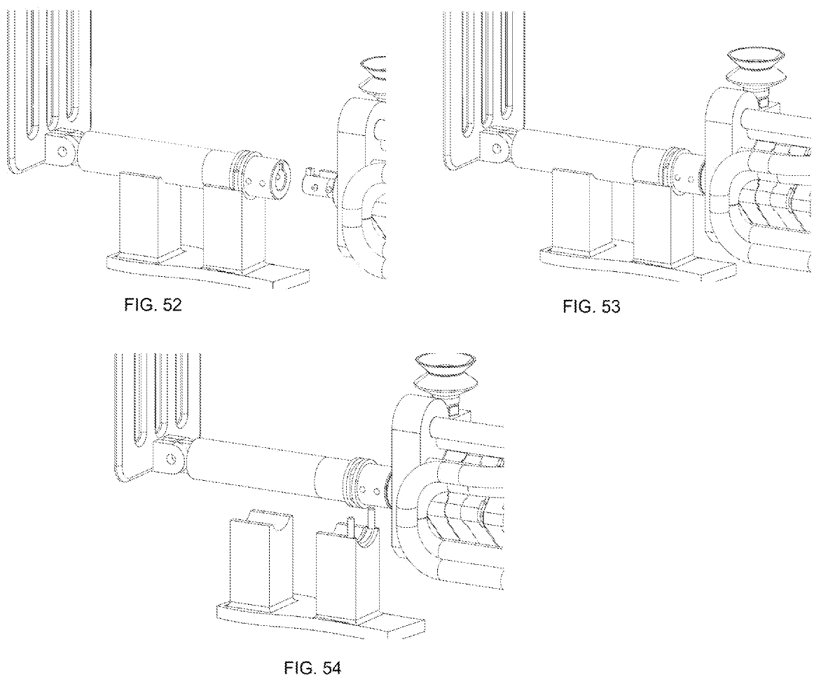

Refer to FIGS. 52-54. The robotic arm aligns the coupling with the orifice in the tool, which is attached to the motor coupling. Then, the robotic arm moves forward and pushes the coupling into the orifice. As the spring pin enters the orifice, the spring is depressed. A s the coupling continues to move forward, the pin will align with the corresponding hole. The spring of the pin then is pushed outward to engage the holes. When the tool is mounted on the motor coupling, the key bar ensures that the tool rotates with the rotating motor. The spring pin ensures that the tool will not slip off the coupling. Once the tool is fixed to the motor coupling, the robot end will move vertically upward to remove the tool from the retaining pin on the holding bay. If replacement of the used tool is required, repeat the process in reverse order.

To perform a cooking/food preparation operation, the robotic arm can perform a set of operations that mimic those of a human chef. As an example, the steps of peeling a carrot areas below:

In this example, the carrot is stored in the middle compartment. Through the controller, a database of all ingredients is stored on a storage system. By referring to the ingredient database, the controller confirms that the carrot is stored in the compartment and also confirms the position of the carrot in the compartment (on the left, in the middle, etc.).

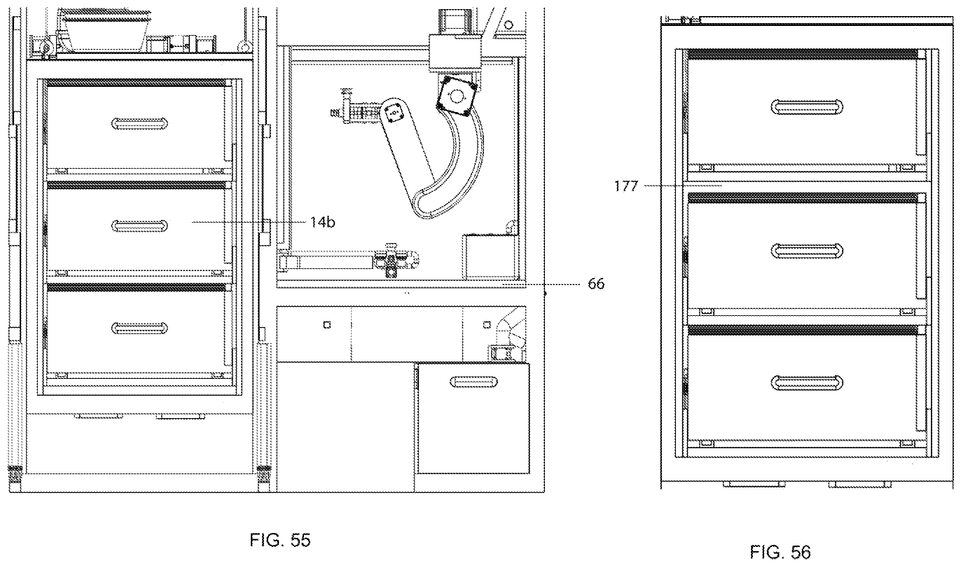

Refer to FIGS. 55 and 56. The second lifting system lifts the compartment box to the appropriate height and the first lifting system creates a gap above the middle tray, in order to pull out the tray.

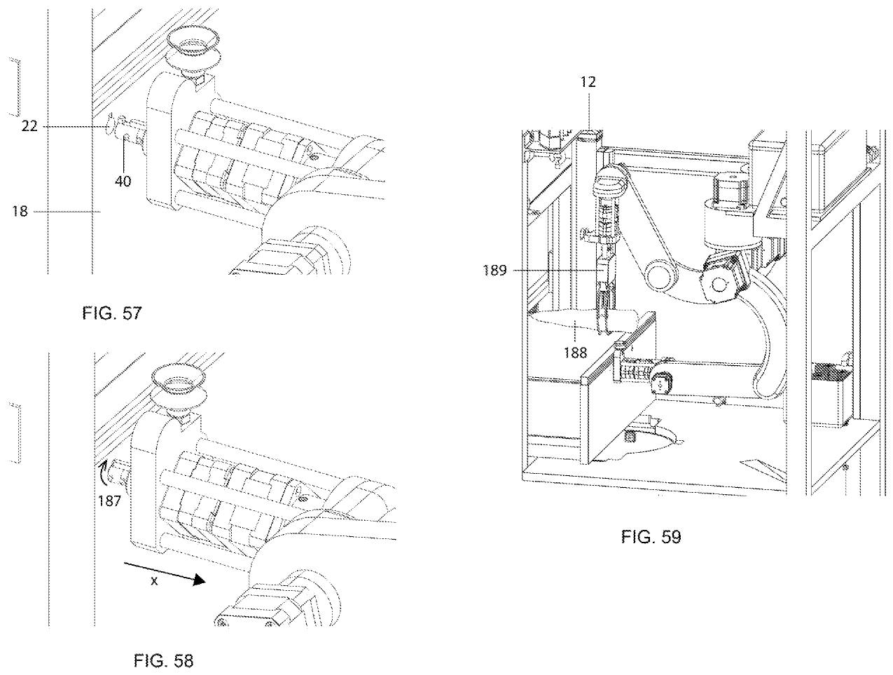

Refer to FIGS. 57 and 58. The first robotic arm aligns the motor coupling 40 with the corresponding recess 22 of the interior tray 18 in the second compartment. The motor coupling moves into the slot and the motor shaft is rotated 90 degrees, as indicated by arrow 187, in a clockwise direction to rotate the key end of the motor coupling to lock onto the recess slot. In the X direction, the robotic arm then pulls the tray out.

Refer to FIG. 59. The sensor 12 sends an image of the contents on the tray to the controller. The controller inspects the image to verify the position of the carrot. The controller then compares the image to a reference image of a carrot in its quality standard database. If the image matches the standard, the controller will send a ‘continue’ signal to the robotic arm, and if it doesn't match the standard, the carrot will be marked as ‘removed’. The ‘Removal Process’ will be described later in this specification.

In this example, when the image matches the standard and the robotic arm receives the ‘continue’ signal. The second robotic arm connects to the gripper tool 189 and removes it from its placed position. The gripper jaw aligns with the carrot 188. The gripper jaws close and the robotic arm removes the carrot from the tray, and the first robotic arm then pushes the tray into the closed position. Next, the shaft of the first robotic arm is rotated 90 degrees in a counterclockwise direction and pulled out of the recess slot. The first robotic arm then aligns and connects the motor coupling to a spike tool, and the spike tool is removed from its original storage position.

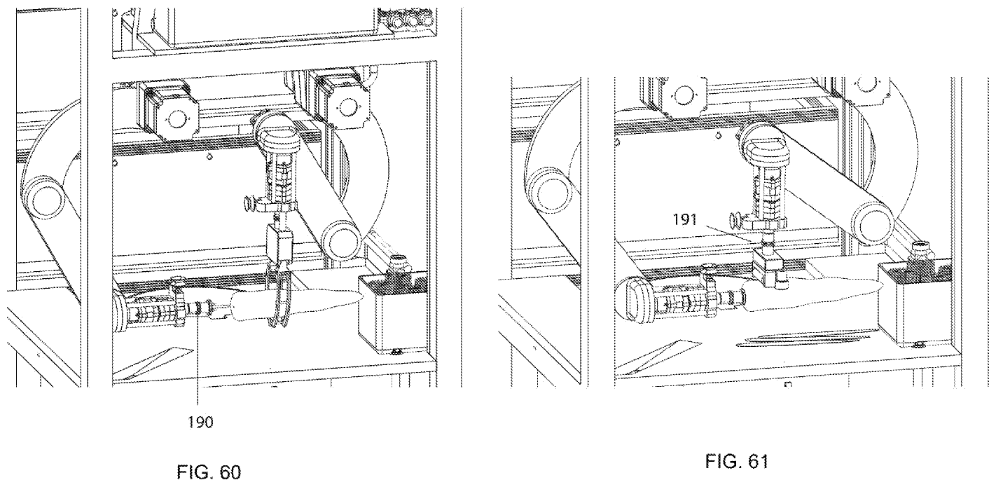

Refer to FIGS. 60 and 61. The first robotic arm then aligns the spike tool 190 with the stem end of the carrot, and the spike tool 190 sticks into the carrot. Thereafter, the second robotic arm opens the jaw and releases the carrot. Then, the second robotic arm drives the gripper tool back to the original parking position. Afterwards, the motor coupling aligns with a peeler tool and removes the peeler tool from its parking position. The blade of the peeler tool 191 is placed above the carrot and passes over the surface of the carrot to remove a certain length of skin. Afterwards, the blade is lifted again, placed in position and the peeling action is repeated. The motor on the first robotic arm rotates the carrot by rotating the spike tool, placing the next carrot under the peeler blade, ready for the next peeling action. This process continues until the entire carrot peeling action is complete.

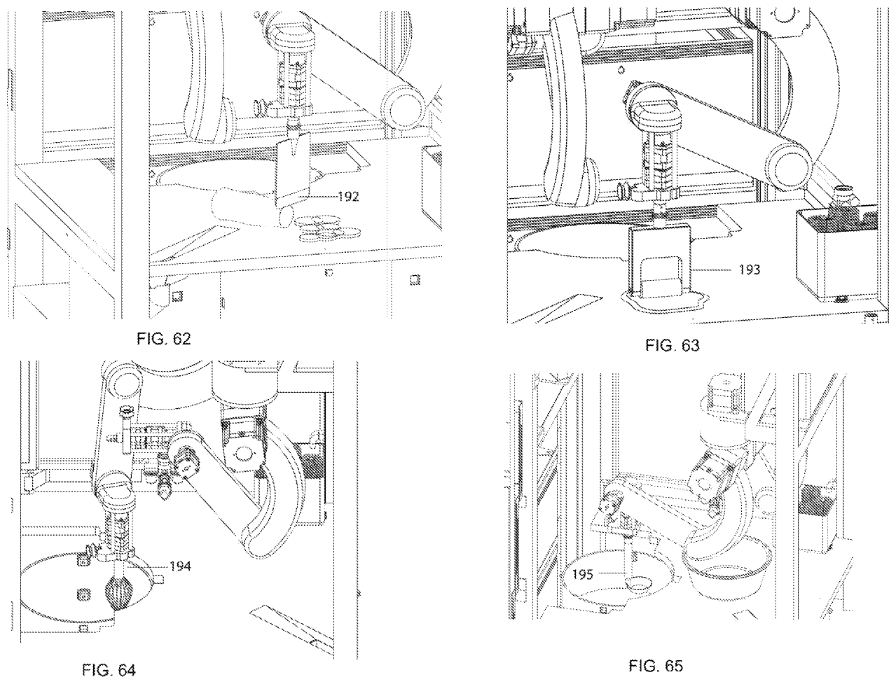

The robotic arms can perform a various of other food preparation or cooking tasks. Refer to FIGS. 62-65, illustrating four different operations. FIG. 62 illustrates slicing a carrot using a chopping tool 192. FIG. 63 illustrates kneading a dough using a roller tool 193. FIG. 64 illustrates a mixing operation using a whisk tool 194. FIG. 65 illustrates the transfer of food from the pot to the serving bowl using a ladle tool 195.

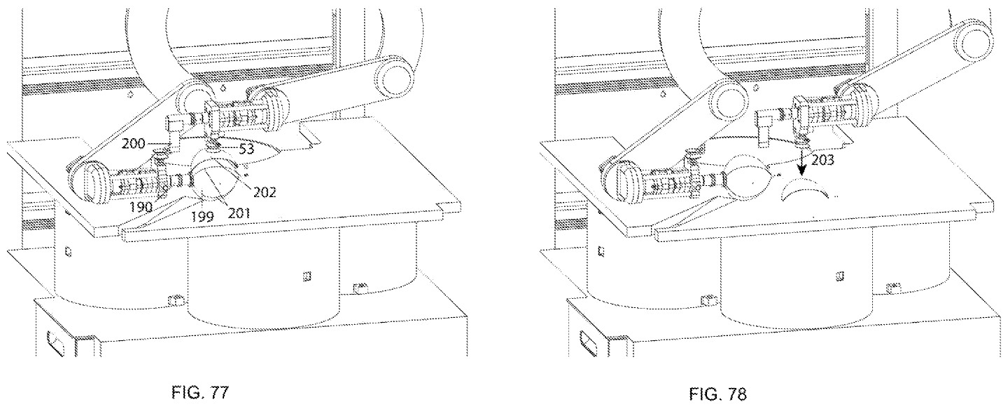

Refer to FIGS. 77 and 78, showing the process of peeling an onion. A spike tool 190 is assembled to the first robotic arm and stuck into the onion 199. A small cutting tool 200 is assembled to the second robotic arm and the tool passes over the surface of the onion to make a series of cuts 201. After each cut, the spike tool rotates the onion 90 degrees to reveal the position of the next cut. This process divides the skin into four sections. The second robotic arm then moves down until its vacuum suction cup 53 contacts the onion skin 202. The vacuum flow control in the motor compartment is then switched on and the suction cup holds of the onion skin in place. Afterwards, the second robotic arm lifts up and removes the onion. Finally, as indicated by arrow 203, the vacuum flow control valve closes and the onion skins fall onto the work table. The process is repeated until all onion skins have been removed.

If, during any food preparation procedure, the camera sensor identifies an ingredient that doesn't match the standard as per the reference database, the machine will not use that ingredient. The sensor will repeat the relevant procedures (e.g., take a picture of another carrot in the storage area and repeat the process until it finds an ingredient that meets the standard) and the controller will keep a record of the ingredients that don't meet the standard. A message will be displayed on the user interface instructing the user to remove the ingredients from the ingredient storage area. The user will be prompted to tap a button on the user interface and the second lifting system will lift the compartment box into place, aligning the compartments with the front covers. The first lifting system lifts or lowers the compartments as required to create a gap to open the compartment. The front cover is then lifted to expose the external tray of the compartment. The user then opens the external tray and removes the ingredients. The user then closes the tray and taps an indicating button on the user interface. With the front cover closed and the compartment box lowered to its rest position, the first lifting system locks the counterweight bars to the bottom compartment and pulls the three compartments together to prevent outside air from entering the refrigeration system.

The procedure as described above is used in reverse order for loading new ingredients into the ingredient storage system. The user selects a ‘load ingredients’ option from the menu on the user interface. The machine then brings the compartment in place and lifts the front cover. The user then opens the tray, loads the ingredients, and closes the tray. The front cover is then close. The robotic arm then opens the tray and takes an image of the tray contents. It will record the position of every ingredient on the tray and stores that information in the ingredient database. This information will be used later when the robotic arm removes the ingredients from the storage area for preparing dishes.

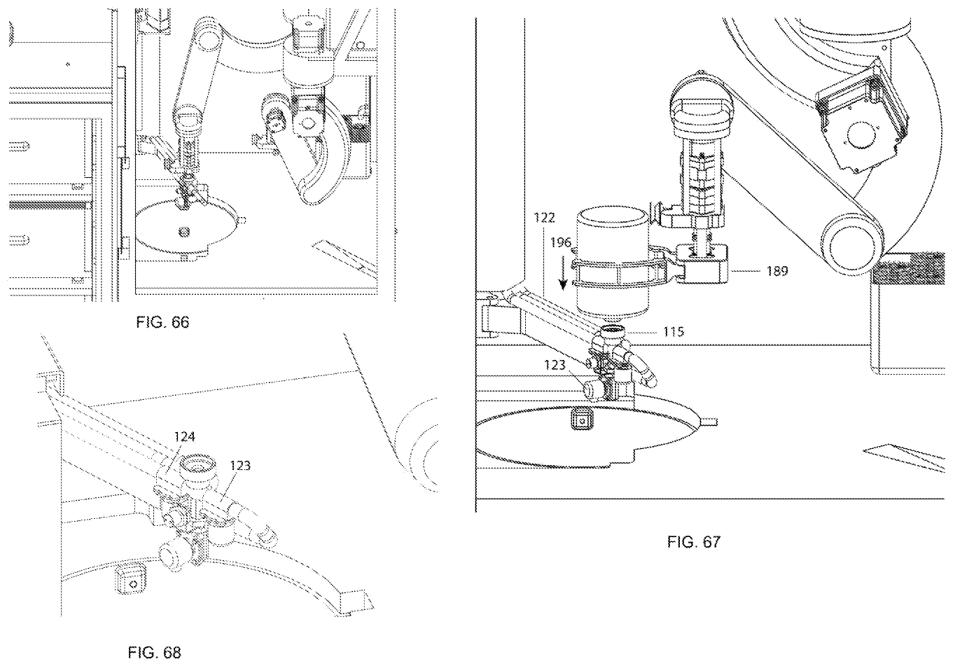

Refer to FIG. 66. To accomplish the function of dispensing the additive, a robotic arm will hook the motor coupling and place it into the cup of the additive dispenser arm and swing the arm into place. The dispensing end can swing to a position above the working table (e.g., to add flour to a dough being kneaded on the working table). The dispensing end may also be swung to a position above the semi-circular recess (e.g., to add cooking oil to a pot).

Refer to FIG. 67. In order to remove the additive bottle from the ingredient storage system, a robotic arm is fitted with the gripper tool 189 to remove the bottle out of the tray. The spring-loaded valve is then placed into the cup 115 and pushes down in a direction indicated by arrow 196) to force the spring-loaded valve upward, and additive begins to flow out of the bottle. The flow control valve 123 opens to dispense the additive. The sensor measures the amount of additive which is being dispensed. When the correct height is reached, the robotic arm lifts and the additive stopes flowing out of the bottle. Then the flow control valve closes.

The process described above is applied for dispensing the liquid additive. When dispensing a dry additive, the additive may not flow freely from the bottle. Once the bottle is secured in place and pushed down into the cup, the flow control valve for compressed air is temporarily opened. Through the air passage underneath the cup 115, compressed air is discharged from pipe 122 into the bottle, and the additive particles shake and flow out of the bottle. The procedure is repeated until a sufficient amount of the additive has been dispensed in place, the bottle is pulled back and the spring-loaded valve is closed.

The dispenser system needs to be cleaned periodically. Refer to FIG. 68. For this purpose, the dispenser arm is swung into position over a used pot that needs to be cleaned. Then, the flow control valve 123 opens and the soap liquid passes through the flow passage. Afterwards, the flow control valve 123 closes, flow control valve 124 opens, and fresh water is rinsed through the flow passage.

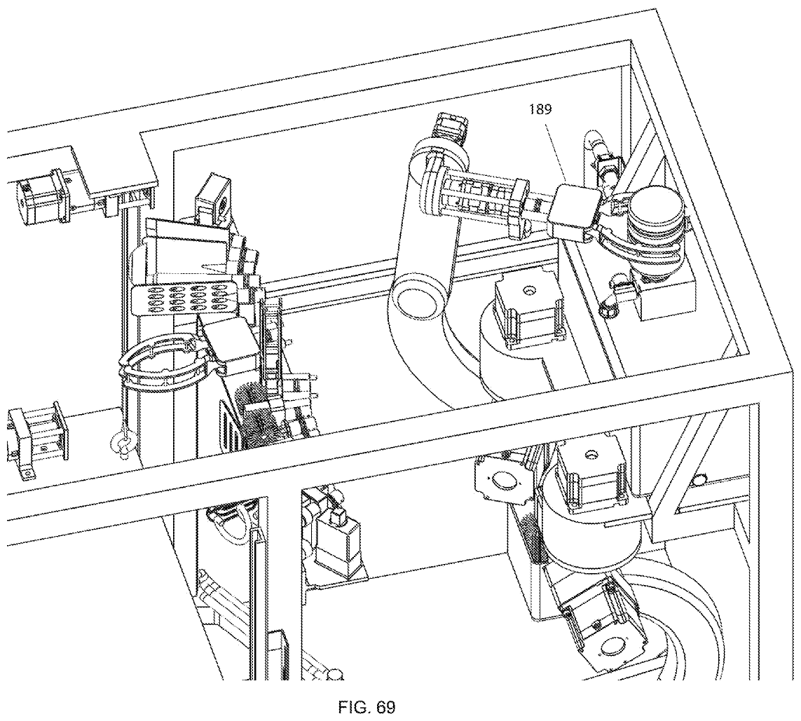

Refer to FIG. 69. When the soap liquid runs out, the soap bottle needs to be replaced with a new one. The robotic arm uses the gripper tool 189 to pull the empty bottle out of the mounting bracket in a horizontal direction. Remove a full bottle from the ingredient storage area and push it into the mounting bracket.

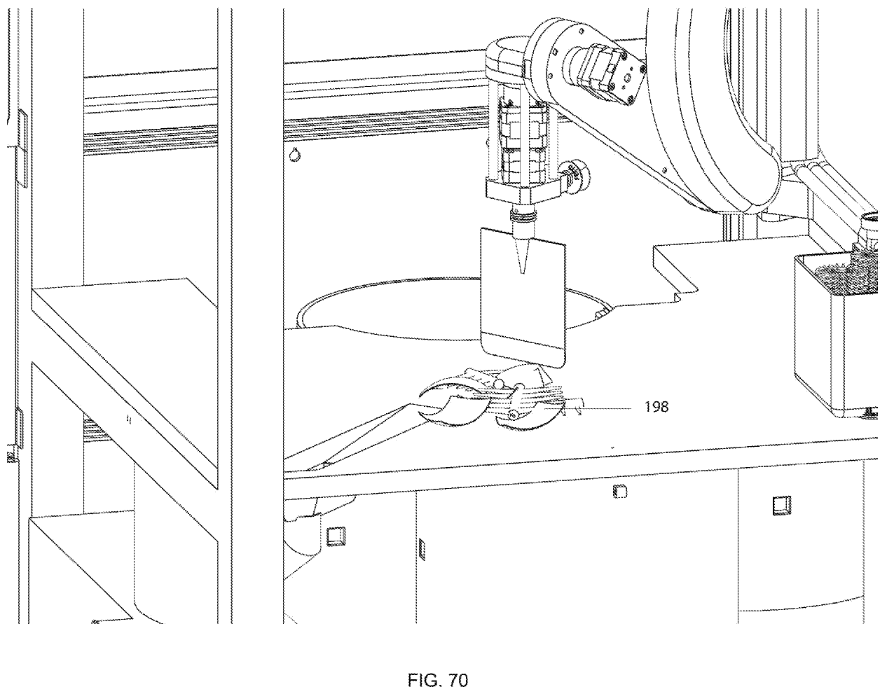

During food preparation, solid waste is generated (vegetable peelings, etc.) Refer to FIG. 70. A chopping tool is mounted on the end of the robotic arm to discard the waste 198. The robotic arm chops up the waste and pushes it into an opening in the working table. The flow control valve is in the open position to allow the waste to fall into the waste bin through the pipe.

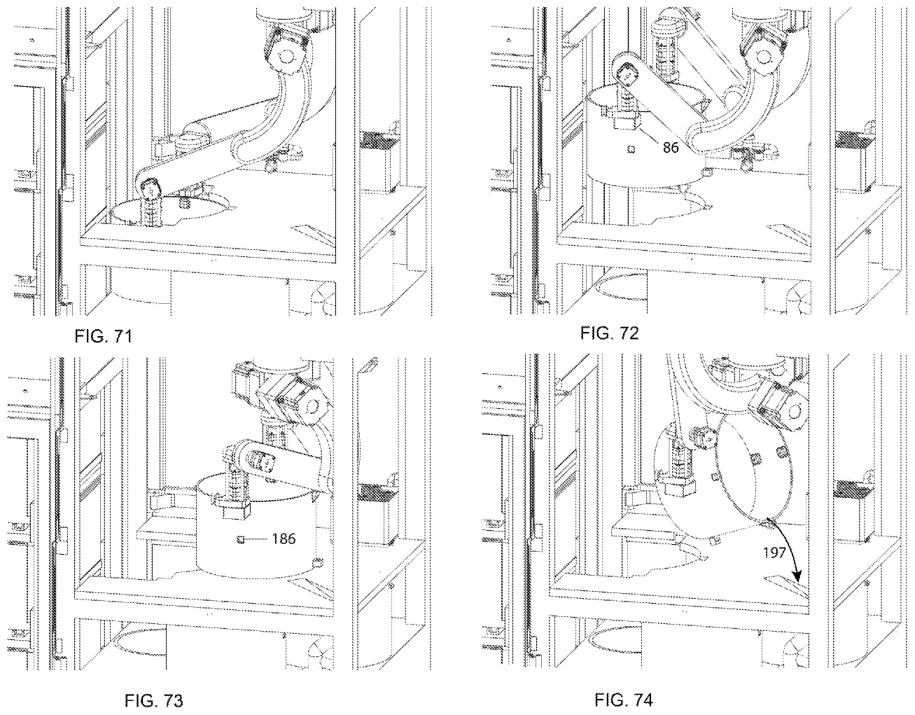

After cooking, liquid waste (e.g., used cooking oil, cooking water, etc.) is sometimes produced. Refer to FIGS. 71 and 72. Each robotic arm has a pot manipulation tool 86 at its end, with a square shaft end located in a square recess at the top of the pot to facilitate lifting the pot. Refer to FIG. 73. The robotic arms put the pot down on the table and the square shaft end of the bottom square recesses 186 enters the pot. Refer to FIG. 74. Afterwards, the robotic arm grabs the corresponding pot and aligns it with the opening. The shaft of the pot manipulation tools begins to rotate and the pot is tilted so that the liquid waste flows into the opening (as indicated by line 197). The flow control valve in the waste disposal system is closed, and the liquid waste flows out from the rear of the machine through the pipe.

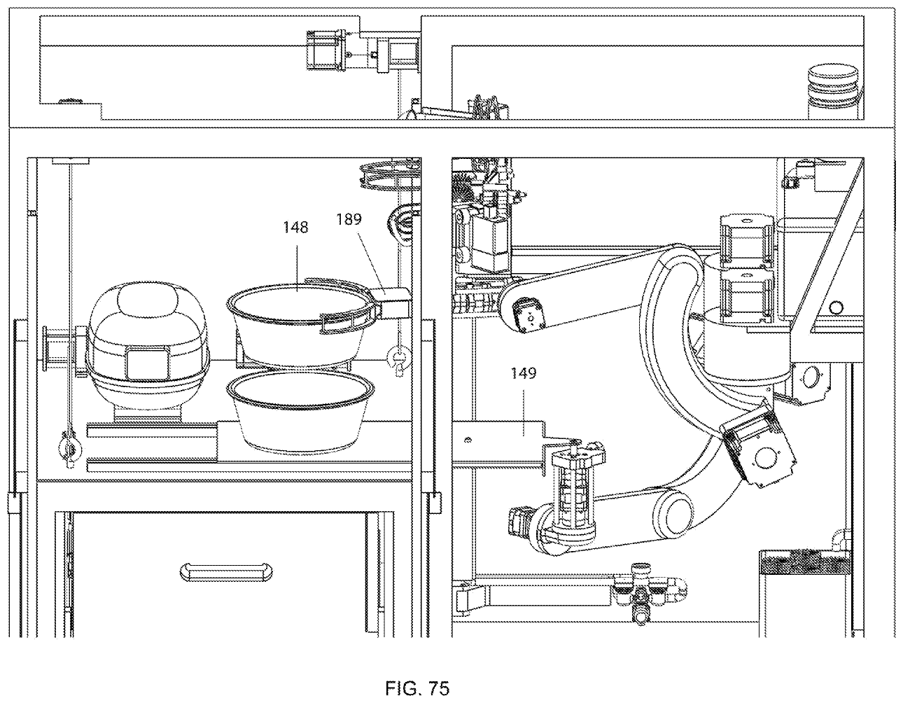

Refer to FIG. 75. In order to remove the serving bowl 148 from the tray, a robotic arm hangs its coupling in the opening of a flat tray 149 and then pulls the tray out. Using a gripper tool 189, the robotic arm removes the serving bowl from the tray and places it on the table. The robotic arm uses the ladle tool (for soup, etc.) or the gripper tool (for large, solid items) to transfer the food from the pot to the serving bowl. Using the pot handling tools, the materials from the pot can also be poured directly into the serving bowl.

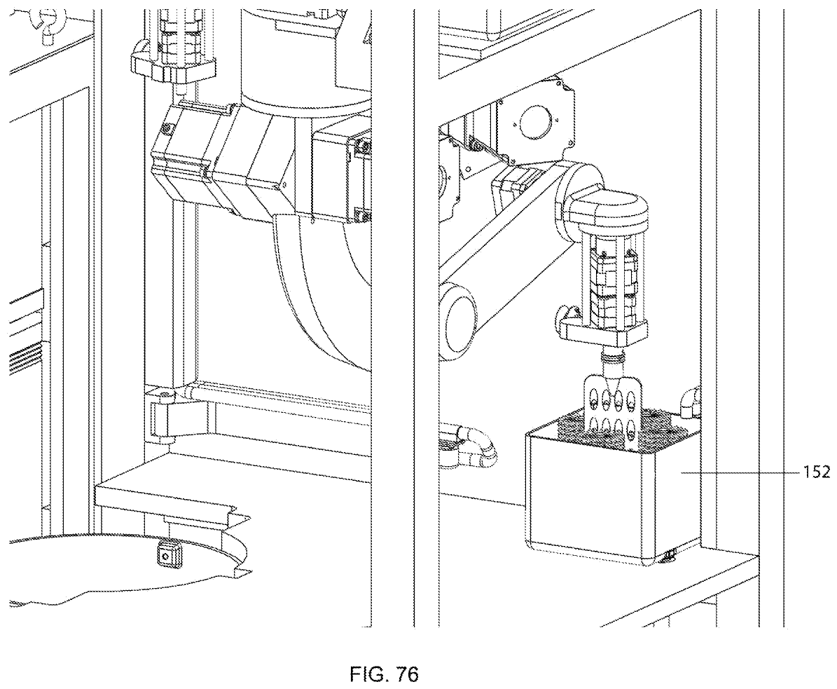

Refer to FIG. 76. The basin vessel on the washing station 152 is filled with soap liquid to clean the tool. The robotic arm holds the tool above the basin vessel to push the tool in and out of the vessel repeatedly. Through the operation, the tool is rubbed against the bristles to remove the dirt. At the end of the process, the outlet valve opens and the used water flows out of the vessel. Then, the outlet valve is closed and the vessel is filled with fresh water. The robotic arm then pushes the tool into the tank again to remove the soap liquid from its surface. After that, the outlet valve opens to release the used liquid waste. The robotic arm then removes the tool from the basin vessel, the motor shaft at the end of the motor then begins to rotate rapidly. The motor coupling transmits the rotational motion to the tool, which then rotates rapidly, sending droplets of water flying off the surface of the tool and drying it.

### Alternative Embodiments of the Invention

This document and the accompanying drawings describe only one embodiment of the present invention. However, a number of other embodiments are possible, for example (but not limited to):

The food storage system may include both refrigerated and non-refrigerated rooms.

The set of trays and their arrangement, as described in this embodiment, demonstrates one arrangement for accessing the ingredient passage from the outside of the machine or the inside of the machine. The design may also have other embodiments, for example an internal cylindrical storage compartment and an external cylindrical cover with a common rotation axis.

In present invention, the robotic arm is described as ‘a system consisting of several rigid parts rotating relative to each other’. The present invention covers any type of robotic arm, such as (but not limited to) a flexible elephant trunk type of robotic arm, or a robot head connected to a cable lift positioning system.

The machine may contain only one robotic arm, while it may also contain 3 or more robotic arms.

The ‘system for coupling a tool to a robotic arm’ as described in the present invention is only one of the embodiments of the present invention. Other embodiments are possible, such as a screw locking system.

The parking bay system for the tools is described as a ‘structure with constraining protrusion’. However, in another embodiment, it may consist of a magnetic constraining system.

The number of the pots in the cooking system may be more or less than 4.

The pots may be of the same shape and size or different.

The ‘cooking pots’ may also refer to a stirring pots.

In this embodiment, the rotation system is used to move the cooking pots to different positions. Other embodiments are possible, such as using a stacking system or a linear system.

In this embodiment, there is only one sensor connected to the controller. In other variations of the machine, there may be several sensors attached to the machine, for example an odor detection sensor for monitoring the freshness of the ingredients in the storage area.

The frame in this embodiment is ‘a structure consisting of long members essentially arranged in horizontal and vertical orientations’. However, the frame in the present invention may employ other support structures.

The system for washing tools is described as ‘a vessel containing brushes’. Other embodiments are possible, such as a high-pressure hose attached to the end of the robotic arm.

In this embodiment, a basin vessel is used for alternately storing soap liquid and fresh water. Another embodiment of the present invention may include a dedicated soap liquid basin vessel and a dedicated fresh water basin vessel.

The additive dispensing system described in the present invention is only one embodiment of the present invention in this part. Other embodiments may include: an additive bottle mounted in a carousel above the food dispensing area, or the entire dispensing system mounted at the end of one of the robotic arms.

In present invention, the amount control module in the additive dispensing system is described as ‘a sensor for measuring the amount of additive through an opening window and a flow control sensor’. In other embodiments of the present invention, the amount control system may also include, but is not limited to, an auger screw dosage system and the like.

In present invention, the anti-rotation system is described as ‘a mechanism for preventing the pots and the brush power tools from rotating with the motor shaft”. Other embodiments of the present invention include, for example, but are not limited to, a clutch system.

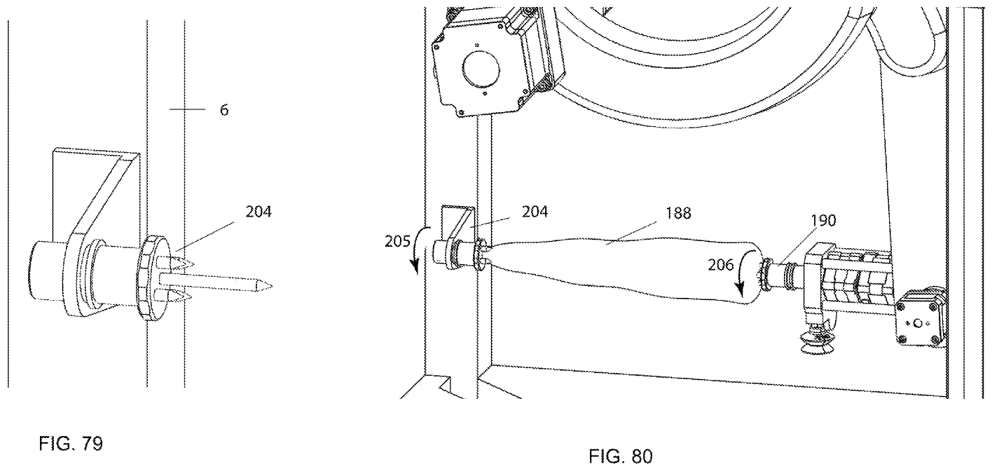

The machine may be equipped with a rotatable spike tool for keeping one end of the vegetable stable while its other end is connected to a rotating tool fixed on the end of the robotic arm. Refer to FIG. 79. The rotatable spike tool 204 is mounted on the frame 6. Refer to FIG. 80. One end of carrot 188 is fixed on the rotatable spike tool, and the other end is fixed on the spike tool 190. The rotation of the spike tool 190 is indicated by arrow 205. The rotational motion is transmitted so that the tool 205 rotates along with it, as indicated by arrow 206.

The rotatable spike tool may be permanently fixed to the frame; alternatively, it may be used as a movable tool that is stored in a tool set and removably mounted in a holding bay on the frame when in use.

In an alternative embodiment, the spike tool may be non-rotating.

Some parts of the tools may be spring-loaded. Refer to FIG. 81. A clamping tool 207 is used to depress an object while cutting it. It consists of a fixed part 208, a moving part 209, two guide shafts 210, and two springs 211. The spring system dampens the pressure exerted on the object so that the object is not crushed when the pressure is applied downward.

In the clamping tool 207, the function is achieved by means of a coil. In other tools, this may be achieved by a leaf spring.

A vacuum generator (using an air compressor and the venturi principle) can be used to generate vacuum suction for picking up items; or a high flow vacuum system can also be created as found in a household vacuum cleaner.

The present invention is sufficiently described for a clearer disclosure, and the prior art will not be enumerated.

Finally, It should be noted that: the above embodiments are only used to illustrate the technical solutions of the present invention, and are not intended to limit them; Although the present invention has been described in detail with reference to the foregoing embodiments, a person of ordinary skill in the art should understand that: it is still possible to make a modification to the technical solutions described in the foregoing embodiments, or to make equivalent substitutions for some of the technical features therein, and it is obvious to a person of skill in the art that a combination of multiple technical solutions is possible in the present invention. These modifications or substitutions do not cause the essence of the corresponding technical solutions depart from the spirit and scope of the technical solutions of the embodiments of the present invention.

I claim:

1. An automatic cooking machine, comprising at least one robotic arm, multiple detachable set of tools for food preparation and cooking, a mechanism for attaching the set of tools for food preparation and cooking to the robotic arm, a collection of cooking pots, a pot rotator adapted to rotate the cooking pots about a common axis, and an ingredient storage system.

2. The automatic cooking machine of to claim 1, wherein the ingredient storage system is positioned independently of the robotic arm within a horizontal projection plane and comprises at least two vertically aligned, non-fixed storage compartments, together with a mechanism for vertically elevating and lowering these storage compartments.

3. The automatic cooking machine of claim 2, wherein each storage compartment comprising a base, a first slider arrangement, an exterior tray, a second slider arrangement, and an interior tray.

4. The automatic cooking machine of claim 3, wherein both the exterior and interior trays are made of insulating material, the exterior tray being connected to the base by the first slider arrangement, while the interior tray being connected to the exterior tray by the second slider arrangement, which slides horizontally back and forth towards the direction of the robotic arm, with the first slider arrangement sliding horizontally and perpendicularly to the sliding direction of the second slider arrangement.

5. The automatic cooking machine of claim 2, wherein a refrigeration system is provided directly above the uppermost storage compartment, the cold end of the refrigeration system being in communication with the uppermost storage compartment, and each storage compartment being equipment with an air passage to facilitate the flow of air into the adjacent storage compartment.

6. The automatic cooking machine of claim 5, wherein the common axis of rotation of the pot rotator is oriented vertically, and the automatic cooking machine includes a rotating arm connected to the cooking pots, while the shaft of the pot rotator is connected to a rotating motor.

7. The automatic cooking machine of claim 6, wherein at least one cooking plate is placed on the path of rotation of the cooking pots.

8. The automatic cooking machine of claim 7, wherein a horizontal table is provided directly above the cooking pots, the table covering substantially the entire width and length of the automatic cooking machine except for the area occupied by the ingredient storage system, and wherein the gap between the lower side of the table and the upper edge of the uppermost cooking pot is small enough to allow the cooking pot to slide, and wherein the table contains a hole cut at the center of the rotation radius of the cooking pot, and the size and shape of the hole being the same as that of the largest cooking pot.

9. The automatic cooking machine of claim 8, wherein an external water supply port is provided in communication with a hose, with the hose itself being connected to the robotic arm.

10. The automatic cooking machine of claim 9, wherein a vacuum generator is provided with a vacuum port connected to a vacuum pipe, and the vacuum pipe is connected to the robotic arm.

11. The automatic cooking machine of claim 10, wherein a waste bin is positioned beneath the table and is retrievable, and a mechanism is provided for holding the waste bin in place.

12. The automatic cooking machine of claim 11, wherein at least one sensor for recording position information is provided, and the sensor is connected to a computerized controller.

13. The automatic cooking machine of claim 12, wherein a basin vessel for cleaning tools is provided.

14. The automatic cooking machine of claim 13, comprising a housing and a sliding cover.

15. The automatic cooking machine of claim 14, wherein a user interface device connected to the computerized controller is provided on the outer surface of the machine.

16. The automatic cooking machine of claim 15, comprising at least one removable serving bowl.

17. The automatic cooking machine of claim 16, wherein a water tank is provided, one end of the tank being connected to the external water supply port and the other end being connected to the hose.

18. The automatic cooking machine of claim 17, wherein at least one of the set of tools for food preparation and cooking is a cutting tool.

19. The automatic cooking machine of claim 18, wherein a detachable brush tool is provided and connected to the robotic arm.

20. The automatic cooking machine of claim 19, comprising at least one detachable gripper tool, and a mechanism for connecting the gripper tool to the robotic arm, and wherein the water tank contains a heater element and the diversion outlet is connected to a flow control valve in communication with the water tank.
